(19) United States
(12) Patent Application Publication
(10) Pub. No.: US 2018/0373677 A1
(43) Pub. Date: Dec. 27, 2018

(54) Apparatus and Methods of Providing Efficient Data Parallelization for Multi-Dimensional FFTs

(71) Applicant: Jaber Technology Holdings US Inc., Wimberley, TX (US)

(72) Inventors: Marwan A. Jaber, Saint-Leonard (CA); Radwan A. Jaber, Saint-Leonard (CA)

(73) Assignee: Jaber Technology Holdings US Inc., Wimberley, TX (US)

(21) Appl. No.: 15/981,331

(22) Filed: May 16, 2018

Related U.S. Application Data
(60) Provisional application No. 62/506,942, filed on May 16, 2017.

(51) Int. Cl. G06F 17/14; G06F 15/80

(52) U.S. Cl. CPC G06F 17/142; G06F 15/803

(57) ABSTRACT

In some embodiments, an apparatus may include a memory configured to store data at a plurality of addresses and a processor circuit including a plurality of processor cores. Each processor core may include multiple threads. The processor circuit may be configured to subdivide an input data stream into a plurality of three-dimensional matrices corresponding to a number of processor cores of the processor circuit. The processor circuit may be further configured to associate each matrix with a respective one of the plurality of processor cores and determine concurrently a three-dimensional FFT for each matrix of the plurality of three-dimensional matrices within the respective one of the plurality of processor cores to produce an FFT output.

### NOTICE OF COPYRIGHTS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The present disclosure is generally related to the field of data processing, and more particularly to data processing apparatuses and methods of providing Fast Fourier transformations, such as devices, systems, and methods that perform real-time signal processing and off-line spectral analysis. In some aspects, the present disclosure is related to a multi-core or multi-threaded processor architecture configured to implement a high-performance parallel multi-dimensional Fast Fourier Transform (FFT).

### BACKGROUND

Since the rise of multi-core processors that became commercially available a decade ago, the parallelization of sequential FFTs on high-performance multi-core devices has received the attention of numerous researchers. A vast body of theoretical research has proposed different parallelizing techniques, different multicore architectures, and different network topologies, which will be dedicated to the FFT computation in parallel. In order to reduce the communication overhead, different network topologies were proposed such as Network-on-Chip (NoC) environment (J. H. Bahn, J. Yang, N. Bagherzadeh, “Parallel FFT Algorithms on Network-on-Chips”, 5^{th} International Conference on Information Technology, Las Vegas, April 2008, pp. 1087-1093) and Smart Cell Coarse Grained Reconfigurable Architecture (C. Liang and X. Huang. “Mapping Parallel FFT Algorithm onto Smart Cell Coarse Grained Reconfigurable Architecture”, IEICE Transaction on Electronic, Vol E93-C, No. 3 Mar. 2010, pp. 407-415).

### SUMMARY

In some embodiments, an apparatus may include a memory configured to store data at a plurality of addresses and a processor circuit including a plurality of processor cores. Each processor core may include multiple threads. The processor circuit may be configured to subdivide an input data stream into a plurality of three-dimensional matrices corresponding to a number of processor cores of the processor circuit. The processor circuit may be further configured to associate each matrix with a respective one of the plurality of processor cores and determine concurrently a three-dimensional FFT for each matrix of the plurality of three-dimensional matrices within the respective one of the plurality of processor cores to produce an FFT output.

In other embodiments, a method may include automatically subdividing an input data stream into a plurality of three-dimensional matrices corresponding to a number of processor cores of the processor circuit. The method may further include automatically associating each matrix with a respective one of the plurality of processor cores and determining concurrently a three-dimensional FFT for each matrix of the plurality of three-dimensional matrices within the respective one of the plurality of processor cores to produce an FFT output.

In still other embodiments, an apparatus may include a memory configured to store data at a plurality of addresses and a processor circuit including a plurality of processor cores. Each processor core can include multiple threads.

The processor circuit may be configure to subdivide an input data stream into a plurality of matrices corresponding to a number of processor cores of the processor circuit and associate each matrix of the plurality of matrices with a respective one of the plurality of processor cores. The processor circuit may be further configured to determine concurrently, using the plurality of processor cores, a Fast Fourier Transform (FFT) for each matrix of the plurality of matrices within the associated one of the plurality of processor cores to produce a plurality of partial FFTs, and automatically combine the plurality of partial FFTs to produce an FFT output.

### BRIEF DESCRIPTION OF THE DRAWINGS

FIG. 1 depicts a block diagram of a data processing apparatus configured to implement a high-performance parallel multi-dimensional Fast Fourier Transform (FFT), in accordance with certain embodiments.

FIG. 2 depicts a signal flow graph (SFG) of a 16-point Decimation-in-Time (DIT) FFT.

FIG. 3 depicts an SFG of a 16-point Decimation-in-Frequency (DIF) FFT.

FIG. 4 depicts an SFG of a 16-point FFT executed on four processors.

FIG. 5 depicts a pattern of a combination of elements in a 16-point FFT when the data are arranged in a 4×4 two-dimensional square array.

FIG. 6 depicts a two-dimensional transpose for a 16-point FFT on four processor cores.

FIG. 7 depicts a multi-stage Radix-r pipelined FFT.

FIG. 8 depicts a multi-stage r-parallel pipelined Radix-r FFT.

FIG. 9 depicts a two-parallel pipelined Radix-2 FFT structure.

FIG. 10 depicts four-parallel pipelined Radix-2 FFT structure.

FIG. 11 depicts four-parallel pipelined Radix-4 FFT structure.

FIG. 12 depicts eight-parallel pipelined Radix-2 FFT structure.

FIG. 13 depicts eight-parallel pipelined Radix-8 FFT structure.

FIG. 14 depicts a four-parallel pipelined Radix-r FFT structure that requires a Data Reordering Phase in order to complete the combination phase in parallel, as shown in FIGS. 15 and 16.

FIG. 15 depicts a 16-point SFG of a DIT FFT parallel structure that requires a Data Reordering Phase in order to complete the combination phase in parallel.

FIG. 16 depicts a 16-point SFG of a DIF FFT parallel structure that requires a Data Reordering Phase in order to complete the combination phase in parallel.

FIG. 17 depicts a conceptual diagram depicting population of the input data over four cores, in accordance with certain embodiments of the present disclosure.

FIG. 18 depicts a graph of speed (in megaflops the same metrics used in FFTW3 platform) in which NFFTW3 and NIVIKL and NIPP represent our parallelization method versus FFTW3 and INTEL's MKL and IPP FFTs where the numbers 4, 5, 6 . . . represent log₂(N).

FIG. 19 depicts a conceptual SFG for a DIT FFT, which reveals the bottleneck of inter-core communications.

FIG. 20 depicts a conceptual SFG for a DIT FFT, which reveals the bottleneck of inter-core communications.

FIG. 21 depicts a one-dimensional FFT parallel structure with a parallelized combination phase, in accordance with certain embodiments of the present disclosure.

FIG. 22 depicts a block diagram of a four-parallel DIT FFTs (radix-2) on four cores where the results are combined with two radix-4 butterflies in order to compute a 16-points FFT, in accordance with certain embodiments of the present disclosure.

FIG. 23 depicts a block diagram of a multi-stage FFT parallel structure, in accordance with certain embodiments of the present disclosure.

FIG. 24 depicts a block diagram of two parallel Radix-2 pipelined block processing engines (BPEs) connected to two Radix-4 BPEs, in accordance with certain embodiments of the present disclosure.

FIG. 25 depicts a matrix showing storage of a complex two-dimensional matrix into memories.

FIG. 26 depicts a matrix showing parallelization of the two-dimensional FFT by parallelizing the series of 1D FFT (columns and rows wise) over four cores.

FIG. 27 depicts a graph representing a two-dimensional parallelization process over four cores, in accordance with certain embodiments of the present disclosure.

FIG. 28 depicts a block diagram of a two-dimensional FFT parallel structure with parallelized combination phase, in accordance with certain embodiments of the present disclosure.

FIG. 29 depicts MATLAB source code illustrating a two-dimensional FFT data parallelization, in accordance with certain embodiments of the present disclosure.

FIG. 30 shows a block diagram of a three-dimensional partition over four cores.

FIG. 31 depicts a block diagram of three steps of a three-dimensional FFT computational process across four cores.

FIG. 32 depicts a block diagram of a global transpose of a cube process across four cores.

FIG. 33 depicts a block diagram of a first model of a three-dimensional parallelization process over four cores, in accordance with certain embodiments of the present disclosure.

FIG. 34 depicts a block diagram of a second model of a three-dimensional parallelization process over four cores, in accordance with certain embodiments of the present disclosure.

FIG. 35 depicts a block diagram of a third model of a three-dimensional parallelization process over four cores, in accordance with certain embodiments of the present disclosure.

FIG. 36 depicts MATLAB source code illustrating a three-dimensional parallelization process across four cores, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

Most of the FFTs' computation transforms are done within the butterfly loops. Any algorithm that reduces the number of additions/multiplications and the communication load in these loops will increase the overall computation speed. The reduction in computation can be achieved by targeting trivial multiplications, which have a limited speedup or by parallelizing the FFT that have a significant speedup on the execution time of the FFT.

Embodiments of the apparatuses and methods described below may provide a high-performance parallel multi-dimensional Fast Fourier Transform (FFT) process that can be used with multi-core systems. The parallel multi-dimensional Fast Fourier Transform (FFT) process may be based on the formulation of the multi-dimensional FFT (size N₁×N₂× . . . ×Nₙ), as a combination of p FFTs (size N₁/p₁×N₂/p₂× . . . ×Nₙ/pₙ) where p₁×p₂× . . . ×pₙ=p (the total number of cores). These p FFTs may be distributed among the cores (p) and each core performs an FFT of size N₁/p₁×N₂/p₂× . . . ×Nₙ/pₙ. The c partial FFTs may be combined in parallel in order to obtain the required transform of size N. In the discussion below, the speed analyses were performed on a FFTW3 platform for a double precision Multi-Dimensional-FFT, revealing promising results and achieving a significant speedup with only four (4) cores. Furthermore, embodiments of the apparatuses and methods described below can include both the 2D and 3D FFT of size m×n (m×n×q) that is designed to run on p cores, each of which will execute 2D/3D FFT of size (m×n)/p ((m×n×q)/p) in parallel that will be combined later on to obtain the final 2D/3D FFT.

The field of Digital Signal Processing (DSP) continues to extend its theoretical foundations and practical implications in the modern world from highly specialized aero spatial systems through industrial applications to consumer electronics. Although the ability of the Discrete Fourier Transform (DFT) to provide information in the frequency domain of a signal is extremely valuable, the DFT was very rarely used in practical applications. Instead, the Fast Fourier Transform (FFT) is often used to generate a map of a signal (called its spectrum) in terms of the energy amplitude over its various frequency components, at regular (e.g. discrete) time intervals, known as the signal's sampling rate. This signal spectrum can then be mathematically processed according to the requirements of a specific application (such as noise filtering, image enhancing, etc.). The quality of spectral information extracted from a signal relies on two major components: 1) spectral resolution which means high sampling rate that will increase the implementation complexity to satisfy the time computation constraints; and spectral accuracy which is translated into an increasing of the data binary word-length that will increase normally with the number of arithmetic operations.

As a result, the FFTs are typically used to input large amounts of data; perform mathematical transformations on that data; and then output the resulting data all at very high rates. The mathematical transformation can be translated into arithmetic operations (multiplications, summations or subtractions in complex values) following a specific dataflow structure that can control the inputs/outputs of the system. Multiplication and memory accesses are the most significant factors on which the execution time relies. Problems with the computation of an FFT with an increasing N can be associated with the straightforward computational structure, the coefficient multiplier memory accesses, and the number of multiplications that should be performed. In high resolution and better accuracy, this problem can be more and more significant, especially for real-time FFT implementations.

In order to satisfy the time computation constraints of real-time data processing the input/output data flow can be restructured to reduce the coefficient multipliers accesses and to also reduce the computational load by targeting trivial multiplication. Memory operations, such as read operations and write operations, can be costly in terms of digital signal processor (DSP) cycles. Therefore, in a real-time implementation, executing and controlling the data flow structure is important in order to achieve high performance that can be obtained by regrouping the data with its corresponding coefficient multiplier. By doing so, the access to the coefficient multiplier's memory will be reduced drastically and the multiplication by the coefficient multiplier w0 (1) will be taken out of the equation.

Since the rise of multicore systems that became commercially available a decade ago, the parallelization of sequential FFTs on high-performance multicore systems has received the attention of numerous researchers. A vast body of theoretical research has proposed different parallelizing techniques, different multicore architectures, and different network topologies, which will be dedicated to the FFT computation in parallel. In order to reduce the communication overhead, different network topologies were proposed such as Network-on-Chip (NoC) environment (J. H. Bahn, J. Yang, N. Bagherzadeh, “Parallel FFT Algorithms on Network-on-Chips”, 5^{th} International Conference on Information Technology, Las Vegas, April 2008, pp. 1087-1093) and Smart Cell Coarse Grained Reconfigurable Architecture (C. Liang and X. Huang. “Mapping Parallel FFT Algorithm onto Smart Cell Coarse Grained Reconfigurable Architecture”, IEICE Transaction on Electronique, Vol E93-C, No. 3 Mar. 2010, pp. 407-415).

Embodiments of the apparatuses and methods disclosed herein include parallelizing the input data and its corresponding coefficient multipliers over a plurality of processing cores (p), where each core (pᵢ) computes one of the p-FFTs locally. By doing so, the communication overhead is eliminated, reducing the execution time and improving the overall operation of the central processing unit (CPU) core of the data processing device.

In certain embodiments, the computational complexity of an FFT (of size N) is approximately equivalent to the computational complexity of an FFT (size N/p) plus the computational requirement of the combination phase, which would be applied on the most powerful FFTs, such as FFTW, which refers to a collection of C-instructions for computing the DFT in one or more dimensions and which includes complex, real, symmetric, and parallel transforms. In the following discussion, the synthesis and the performance results of the methods are shown based on execution using an FFTW3 Platform.

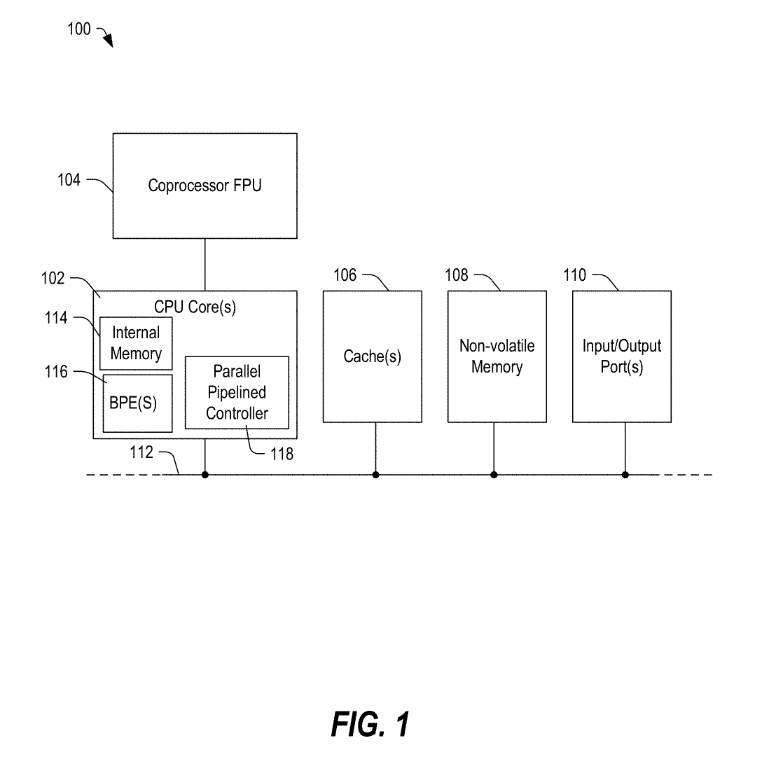

Referring now to FIG. 1, a block diagram of a data processing apparatus is generally indicated as 100. The data processing apparatus 100 may be configured to provide efficient data parallelization for multi-dimensional FFTs, in accordance with certain embodiments of the present disclosure. The data processing apparatus 100 may include one or more central processing unit (CPU) cores 102, each of which may include one or more processing cores. In some embodiments, the one or more CPU cores 102 may be implemented as a single computing component with two or more independent processing units (or cores), each of which may be configured to read and write data and to execute instructions on the data. Each core of the one or more CPU cores 102 may be configured to read and execute central processing unit (CPU) instructions, such as add, move data, branch, and so on. Each core may operate in conjunction with other circuits, such as one or more cache memory devices 106, memory management, registers, non-volatile memory 108, and input/output ports 110.

In some embodiments, the one or more CPU cores 102 can include internal memory 114, such as registers and memory management. In some embodiments, the one or more CPU cores 102 can be coupled to a floating-point unit (FPU) processor 104. Further, the one or more CPU cores 102 can include butterfly processing elements (BPEs) 116 and a parallel pipelined controller 118.

In some embodiments, the one or more CPU cores 102 can be configured to process data using FFT DIF operations or FFT DIT operations. Embodiments of the present disclosure utilize a plurality of BPEs 116 in parallel and across multiple cores of the one or more CPU cores 102. The parallel pipelined controller 118 may control the parallel operation of the BPEs 116 to provide high-performance parallel multi-dimensional FFT operations, enabling real-time signal processing of complex data sets as well as efficient off-line spectral analysis. The partial FFTs can be processed and combined in parallel in order to obtain the required transform of size N.

It should be appreciated that the FFT operations may be managed using a dedicated processor or processing circuit. In some embodiments, the FFT operations may be implemented as CPU instructions that can be executed by the individual processing cores of the one or more CPU cores 102 in order to manage memory accesses and various FFT computations. Other embodiments are also possible. Before explaining the parallelization for multi-dimensional FFTs in detail, an understanding of the signal flow process for an FFT is described below.

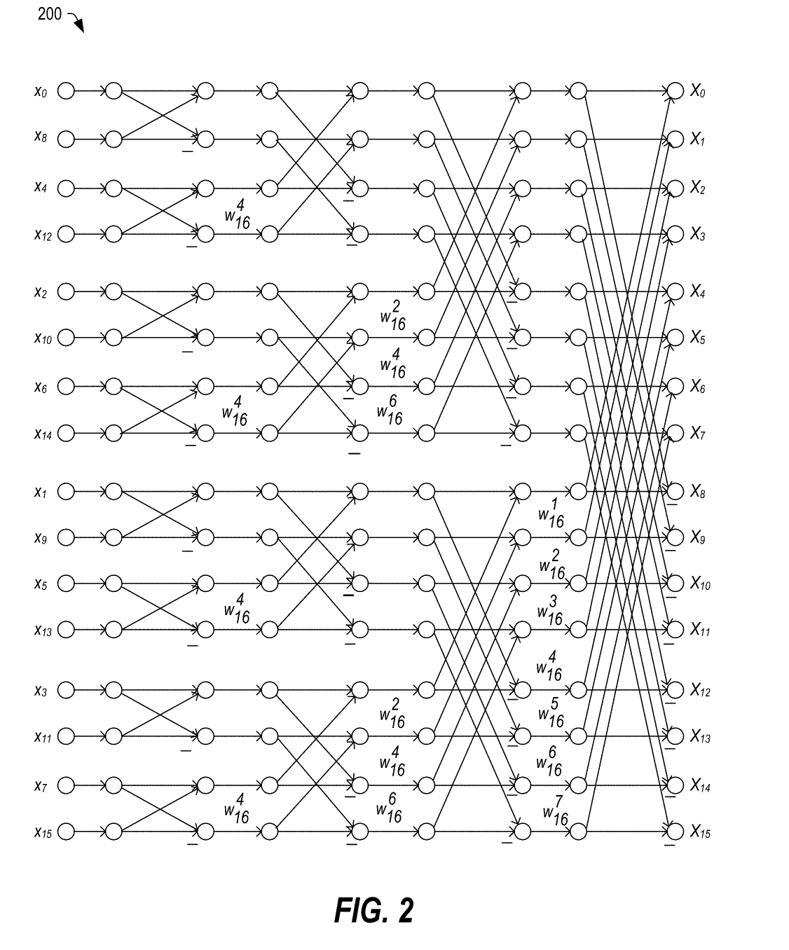

FIG. 2 depicts a signal flow graph (SFG) of a 16-point Decimation-in-Time (DIT) FFT 200. The 16-point DIT FFT 200 may receive sixteen input points (x₀ through x₁₅) and may provide sixteen output points (X₀ through X₁₅). The definition of the DFT is represented by the following equation:

$${X}_{( k )} = {\sum }_{n = 0}^{N - 1} {x}_{( n )} {w}_{N}^{nk} , k ∈ [ 0 , N - 1 ] , \qquad ( 1 )$$

where x(n) is the input sequence, X(k) is the output sequence, N is the transform length, and w_{N} is the Nth root of unity, w_{N}=e^{-j2π/N}. Both x(n) and X(k) are complex valued sequences of length N=r^{S}, where r is the radix.

The DIT FFT 200, as depicted in the SFG, is determined by multiple processing cores, in parallel. The DIT FFT 200 can be applied to data of any size (N) by dividing the data (N) into a number of portions corresponding to the number of processing cores (p). The DIT FFT 200 can be executed on a parallel computer by partitioning the input sequences into blocks of N/p contiguous elements and assigning one block to each processor.

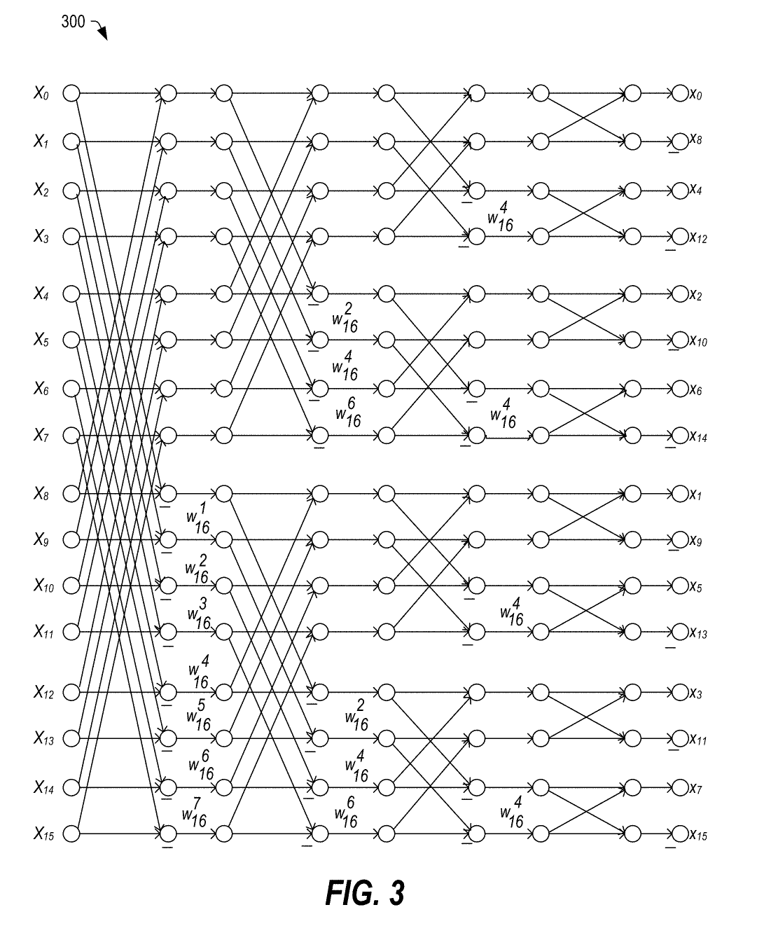

As shown in FIG. 3, an SFG of a 16-point Decimation-in-Frequency (DIF) FFT is shown and generally indicated at 300. The 16-point DIF FFT 300 may receive sixteen input points (x₀ through x₁₅) and may provide sixteen output points (X₀ through X₁₅).

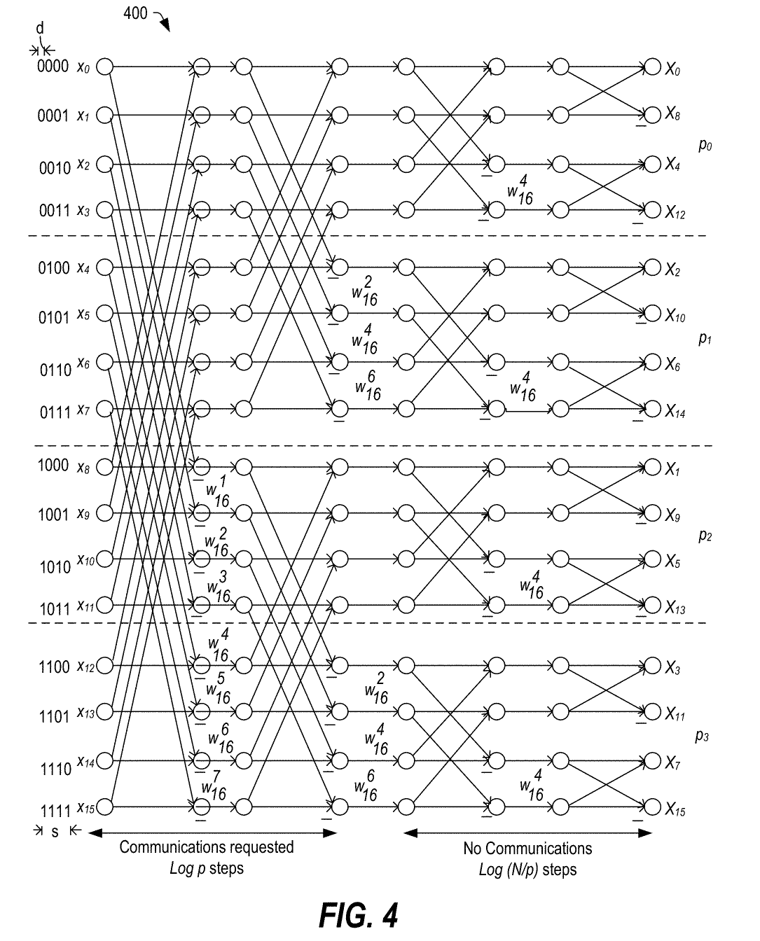

FIG. 4 depicts an SFG of a 16-point FFT 400 executed on four processors (p₀, p₁, p₂, and p₃). In the illustrated 16-point FFT 400, all elements with indices having the same (d) most significant bits are mapped onto the same process. In this example, the first d iterations involve inter-processor communications, and the last (s d) iterations involve the same processors. In some embodiments, the DIF FFT uses a message passing interface to perform one-dimensional transforms works by breaking a problem of size N=N₁N₂ into N₂ problems of size N₁, and N₁ problems of size N₂. In general, the number of processes is p=2^{d}, and the length of the input sequenced is N=2^{S} (where N represents the number of bits).

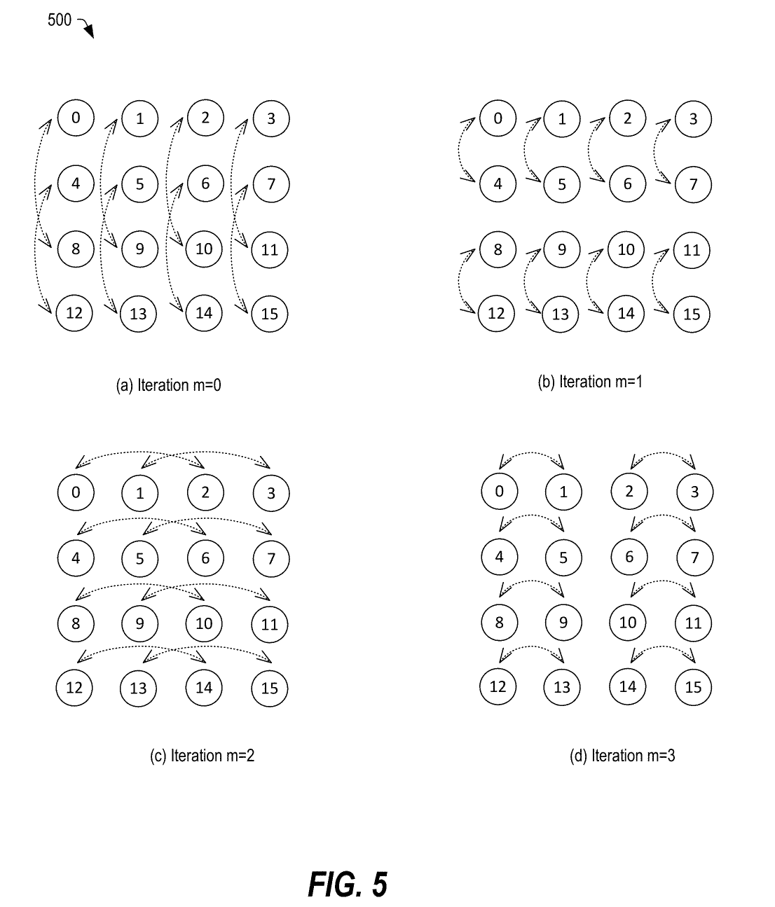

FIG. 5 depicts a pattern of a combination of elements in a 16-point FFT when the data are arranged in a 4×4 two-dimensional square array 500. This problem breaking process can be referred to as a transpose algorithm in which the data are transposed using all-to-all personalized collective communication; so that each row of the data array is now stored in single task. The data are arranged in a 4×4 two-dimensional square array, and the datum may be transposed as shown through the various stages.

The transpose algorithm in the parallel FFTW is based on the partitioning of the sequences into blocks of N/p contiguous elements and by assigning one block to each processor as shown in FIG. 4.

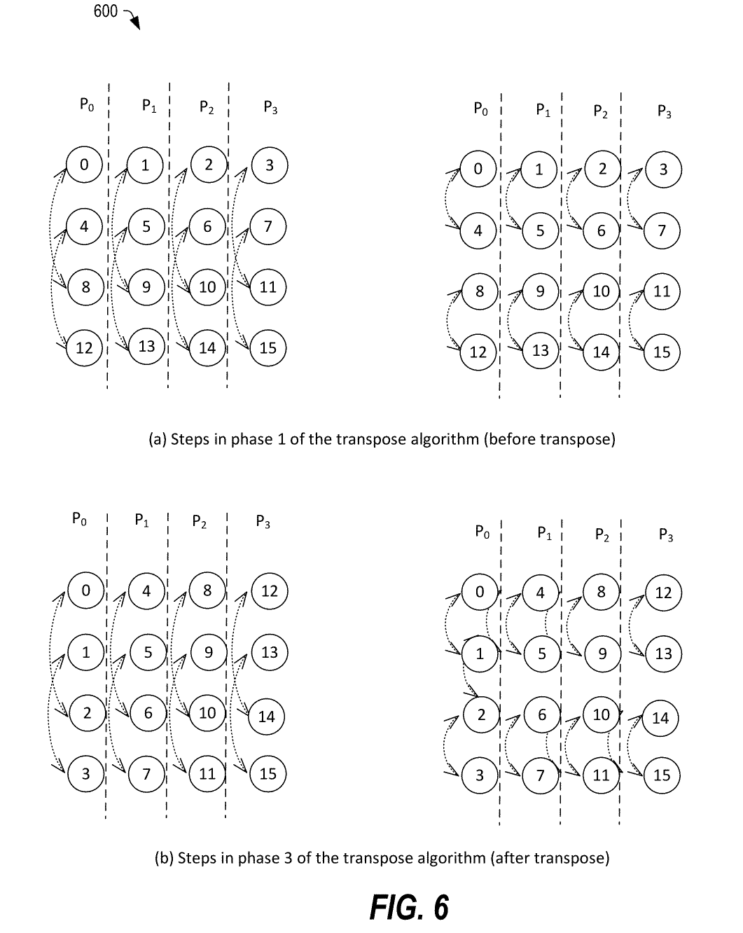

FIG. 6 depicts a two-dimensional transpose 600 for a 16-point FFT on four processor cores. As shown in part a, each column of the 4×4 matrix is assigned to a processor core (P₀, P₁, P₂, or P₃), which core performs steps in phase 1 of the transpose before performance of the transpose operation. As shown in part b, each core performs steps in phase 3 of the transpose after performance of the transpose operation.

The simplest sense of parallel computing is the simultaneous use of multiple compute resources to solve a computational problem, which is achieved by breaking the problem into sub-problems that can be executed concurrently and independently on multiple cores. Let x₍ₙ₎ be the input sequence of size N and let p denote the degree of parallelism, which is multiple of N, equation (1) can be rewritten as follows:

$$\begin{matrix}{X}_{( K )} = {\sum }_{n = 0}^{\frac{N}{p} - 1} {x}_{( pn )} {w}_{N}^{pnk} + {\sum }_{n = 0}^{\frac{N}{p} - 1} {x}_{( pn + 1 )} {w}_{N}^{( pn + 1 ) k} + L + {\sum }_{n = 0}^{\frac{N}{p} - 1} {x}_{( pn + ( p - 1 ) )} {w}_{N}^{( pn + ( p - 1 ) ) k} , & ( 2 ) \\ {X}_{( k )} = {\sum }_{n = 0}^{\frac{N}{p} - 1} {x}_{( pn )} {w}_{\frac{N}{p}}^{nk} + {w}_{N}^{k} {\sum }_{n = 0}^{\frac{N}{p} - 1} {x}_{( pn + 1 )} {w}_{\frac{N}{p}}^{nk} + L + {w}_{N}^{( p - 1 ) k} {\sum }_{n = 0}^{\frac{N}{p} - 1} {x}_{( pn + ( p - 1 ) )} {w}_{\frac{N}{p}}^{nk} & ( 3 )\end{matrix}$$

By defining the ranges v=0, 1, . . . , V≤1 and q=0, 1, . . . , p−1 where the variable V=N/p, the variable k can be determined as follows:

k=v+qV, (4)

As a result, equation (3) could be expressed as follows:

$${X}_{( v + qV )} = {\sum }_{n = 0}^{V - 1} {x}_{( pn )} {w}_{V}^{n ( v + qV )} + {w}_{N}^{( v + qV )} {\sum }_{n = 0}^{V - 1} {x}_{( pn + 1 )} {w}_{V}^{n ( v + qV )} + L + {w}_{N}^{( p - 1 ) ( v + qV )} {\sum }_{n = 0}^{V - 1} {x}_{( pn + ( p - 1 ) )} {w}_{V}^{n ( v + qV )} \qquad ( 5 )$$

The equivalency of the simpler twiddle factors can be expressed as follows:

w_{V}^{nqV}=(w_{V}^{V})^{nq}=(1)^{nq}=1, (6)

Taking advantage of such simplicity, equation (5) can be expressed as follows:

$${X}_{( v + qV )} = {\sum }_{n = 0}^{V - 1} {x}_{( pn )} {w}_{V}^{nv} + {w}_{N}^{( v + qV )} {\sum }_{n = 0}^{V - 1} {x}_{( pn + 1 )} {w}_{V}^{nv} + L + {w}_{N}^{( p - 1 ) ( v + qV )} {\sum }_{n = 0}^{V - 1} {x}_{( pn + ( p - 1 ) )} {w}_{V}^{nv} \qquad ( 7 )$$

If X₍ₖ₎ is the N^{th} order Fourier transform

$${\sum }_{n = 0}^{N - 1} {x}_{( n )} {w}_{N}^{nk}$$

then, X₍₀₎_{₍ᵥ₎}, X₍₁₎_{₍ᵥ₎}, . . . and X₍ₚ₋₁₎_{₍ᵥ₎} will be the N^{th}/p order Fourier transforms given respectively by the following expressions:

$${\sum }_{n = 0}^{V - 1} {x}_{( pn )} {w}_{V}^{nv} , {\sum }_{n = 0}^{V - 1} {x}_{( pn + 1 )} {w}_{V}^{nv} , … and {\sum }_{n = 0}^{V - 1} {x}_{( pn + ( p - 1 ) )} {w}_{V}^{nv} . \qquad ( 8 )$$

Based on the above assumption, equation (7) can be rewritten as follows:

X_{(v+qV)}=X₍₀₎_{₍ᵥ₎}+w_{N}^{v}w_{N}^{qV}X₍ₜ₎_{₍ᵥ₎}+L+w_{N}^{(p-1)v}w_{N}^{(p-1)qV}X₍ₚ₋₁₎_{₍ᵥ₎}, (9)

and, the output matrix of Variable X can be expanded as follows:

$${X}_{( k )} = [ \begin{matrix}{X}_{( v )} \\ {X}_{( v + V )} \\ M \\ {X}_{( v + ( p - 1 ) V )}\end{matrix} ] = [ \begin{matrix}{w}_{N}^{0} & {w}_{N}^{0} & L & {w}_{N}^{0} \\ {w}_{N}^{0} & {w}_{N}^{\frac{N}{p}} & L & {w}_{N}^{\frac{( p - 1 ) N}{p}} \\ M & M & O & M \\ {w}_{N}^{0} & {w}_{N}^{\frac{( p - 1 ) N}{p}} & L & {w}_{N}^{\frac{{( p - 1 )}^{2} N}{p}}\end{matrix} ] \times [ \begin{matrix}{w}_{N}^{0} & 0 & L & 0 \\ 0 & {w}_{N}^{v} & 0 & 0 \\ M & M & O & M \\ 0 & 0 & L & {w}_{N}^{( p - 1 ) v}\end{matrix} ] \times [ \begin{matrix}{X}_{{( 0 )}_{( v )}} \\ {X}_{{( 1 )}_{( v )}} \\ M \\ {X}_{{( p - 1 )}_{( v )}}\end{matrix} ] \qquad ( 10 )$$

In equation (10), the first and second matrix can be recognized, as can the well-known adder tree matrix Tₚ and the twiddle factor matrix W_{N}, respectively. Thus, equation (10) can be expressed in a compact form as follows:

X=TₚW_{N}col(X_{(q)}_{₍ᵥ₎}|q=0,1,K,p−1), (11)

where the twiddle factor matrix W_{N}=diag(w_{N}⁰,w_{N}^{v},w_{N}^{2v},K,w_{N}^{(p-1)v}) and wherein the adder tree matrix is determined as follows:

$${T}_{p} = [ \begin{matrix}{w}_{N}^{0} & {w}_{N}^{0} & {w}_{N}^{0} & L & {w}_{N}^{0} \\ {w}_{N}^{0} & {w}_{N}^{N / p} & {w}_{N}^{2 N / p} & L & {w}_{N}^{( p - 1 ) N / p} \\ {w}_{N}^{0} & {w}_{N}^{2 N / p} & {w}_{N}^{4 N / p} & L & {w}_{N}^{2 ( p - 1 ) N / p} \\ M & M & M & O & M \\ {w}_{N}^{0} & {w}_{N}^{( p - 1 ) N / p} & {w}_{N}^{2 ( p - 1 ) N / p} & L & {w}_{N}^{{( p - 1 )}^{2} N / p}\end{matrix} ] . \qquad ( 12 )$$

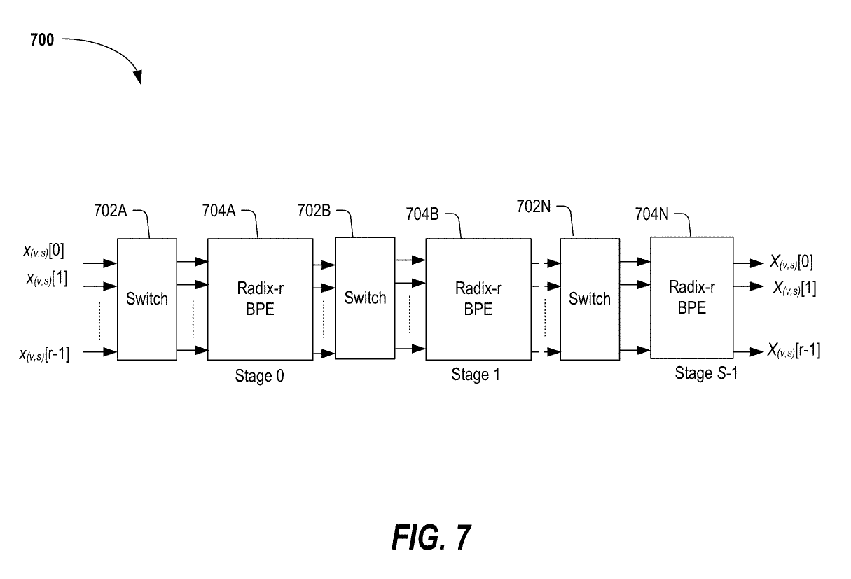

FIG. 7 depicts a multi-stage Radix-r pipelined FFT 700. The FFT 700 can be of length r^{S} and can be implemented in S stages, where each stage (S) performs a radix-r butterfly (FIG. 2). The switch blocks 702 correspond to the data communication buses from the (S−1)^{th} to S^{th} stages where S=logᵣ N and S=0, 1, . . . , S−1. Since r data paths are used, the pipelined BPE achieves a data rate S times the inter-module clock rate. The Radix-r BPEs 704 correspond to the BPE stages.

Based on the assumption that if X(k) is the Nth order Fourier transform

$${\sum }_{n = 0}^{N - 1} {x}_{( n )} {w}_{N}^{nk}$$

then, X₍₀₎_{₍ᵥ₎}, X₍₁₎_{₍ᵥ₎}, . . . and X₍ₚ₋₁₎_{₍ᵥ₎} will be the Nth/p order Fourier transforms given respectively by the following expressions

$${\sum }_{n = 0}^{V - 1} {x}_{( pn )} {w}_{V}^{nv} , {\sum }_{n = 0}^{V - 1} {x}_{( pn + 1 )} {w}_{V}^{nv} , … and {\sum }_{n = 0}^{V - 1} {x}_{( pn + ( p - 1 ) )} {w}_{V}^{nv} .$$

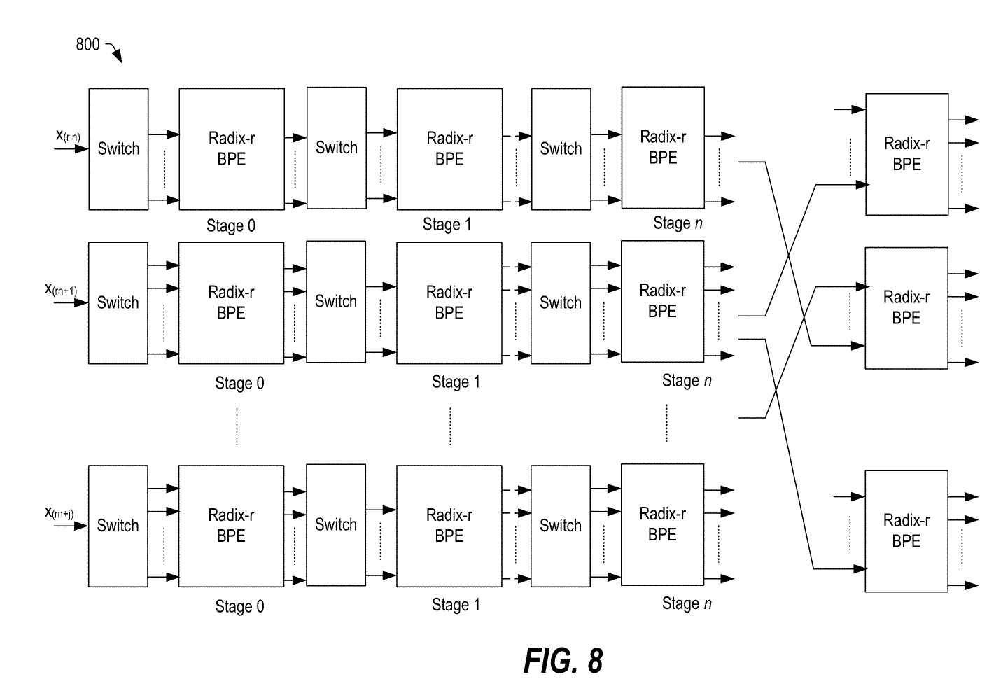

FIG. 8 depicts a multi-stage r-parallel pipelined Radix-r FFT 800. The FFT 800 illustrates the parallel implementation of r radix r pipelined FFTs of size N/r, which are interconnected with r radix r butterflies in order to complete an FFT of size N. The factorization of an FFT can be interpreted as a dataflow diagram (or Signal Flow Graph) depicting the arithmetic operations and their dependencies. Thus, by labeling the S^{th} stage's r outputs of each pipeline by OUT_{(j,p)}, which are interconnected according to equation (10) to r butterfly processing elements (BPEs) labeled as BPE_{(p,j)} in which j=0, 1, . . . , r−1 and p=0, 1, . . . , r−1.

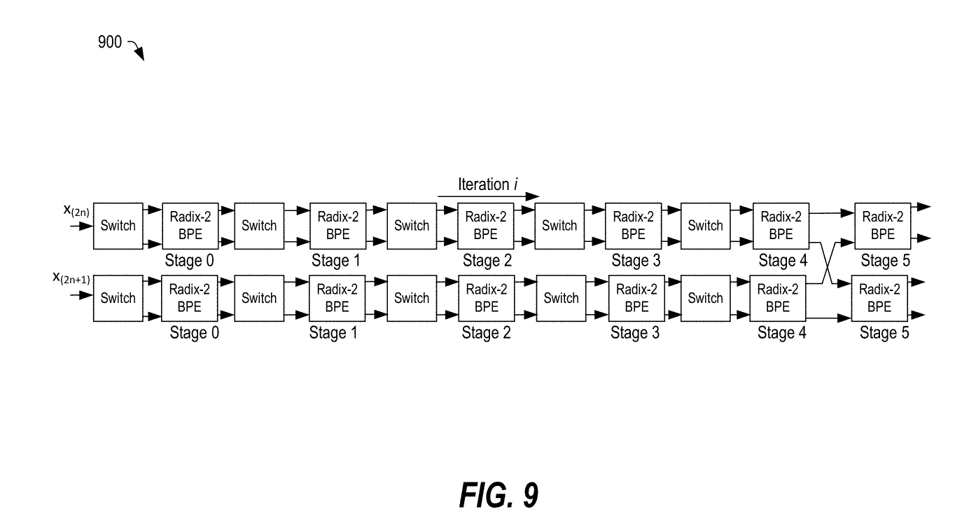

This interconnection is achieved by feeding the j^{th} output of the p^{th} pipeline to the p^{th} input of the j^{th} butterfly. For instance, the output labeled zero of the second pipeline will be connected to the second input of the butterfly labeled zero. Based on equations (10) and (11), FIGS. 9 to 13 depict different parallel pipelined FFT architectures.

FIG. 9 depicts a multi-stage two-parallel pipelined Radix-2 FFT structure 900. The FFT structure 900 includes six stages (0 through 5) wherein one of the outputs of the fifth stage of the first pipeline is provided to the input of the sixth stage of the second pipeline. Similarly, one of the outputs of the fifth stage of the second pipeline is provided to an input of the sixth stage of the first pipeline.

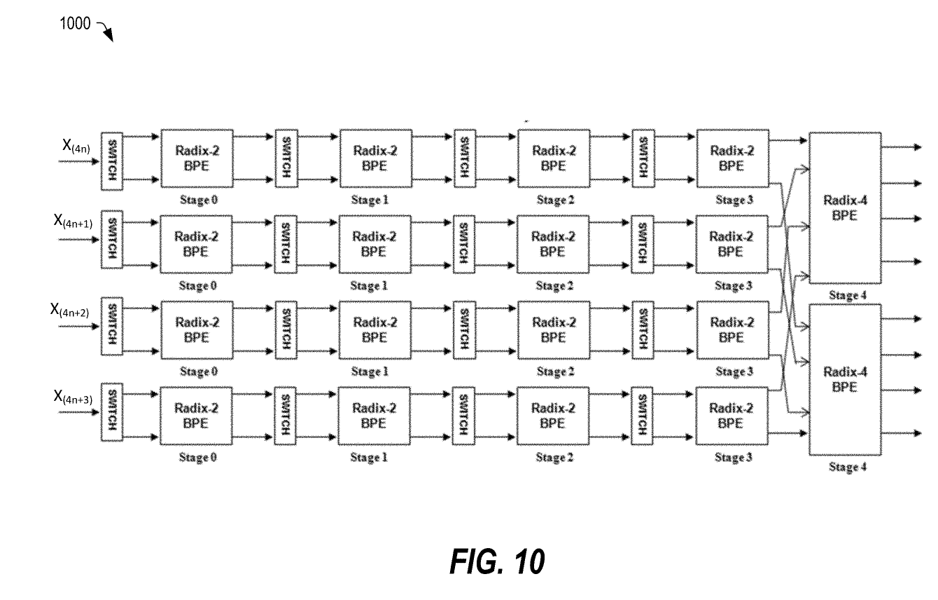

FIG. 10 depicts a multi-stage four-parallel pipelined Radix-2 FFT structure 1000. In the illustrated example, the FFT structure 1000 includes five stages (0 through 4). Outputs are interchanged between the pipelines of the fourth and fifth stages.

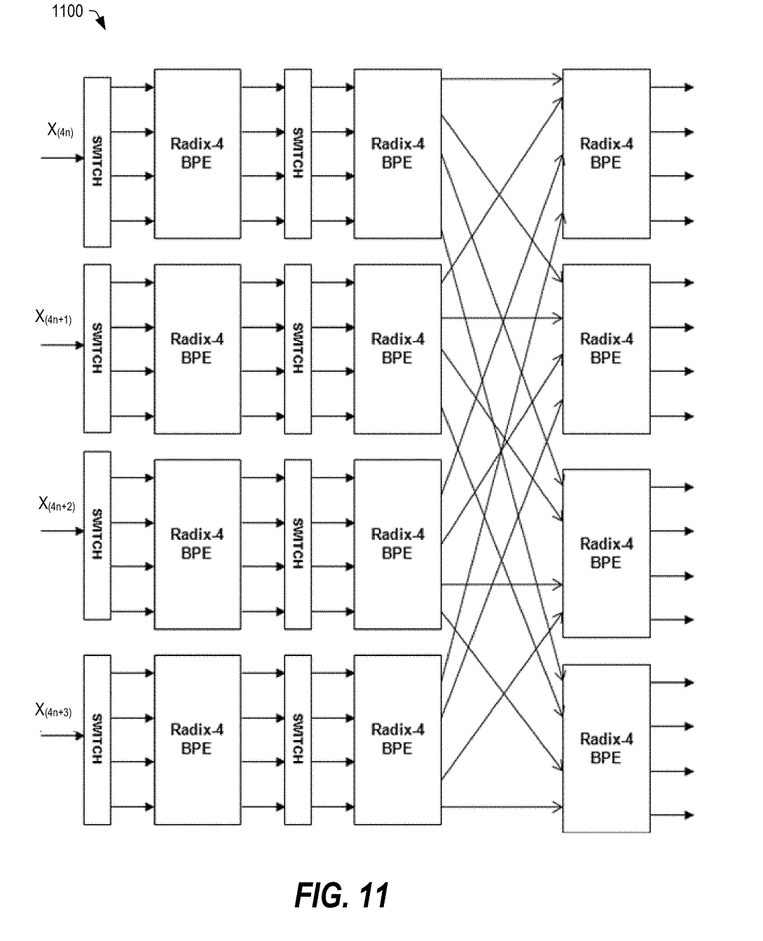

FIG. 11 depicts a multi-stage four-parallel pipelined Radix-4 FFT structure 1100. The FFT structure 1100 includes three stages, where the outputs of the pipelined stages are interchanged between the second and third stages.

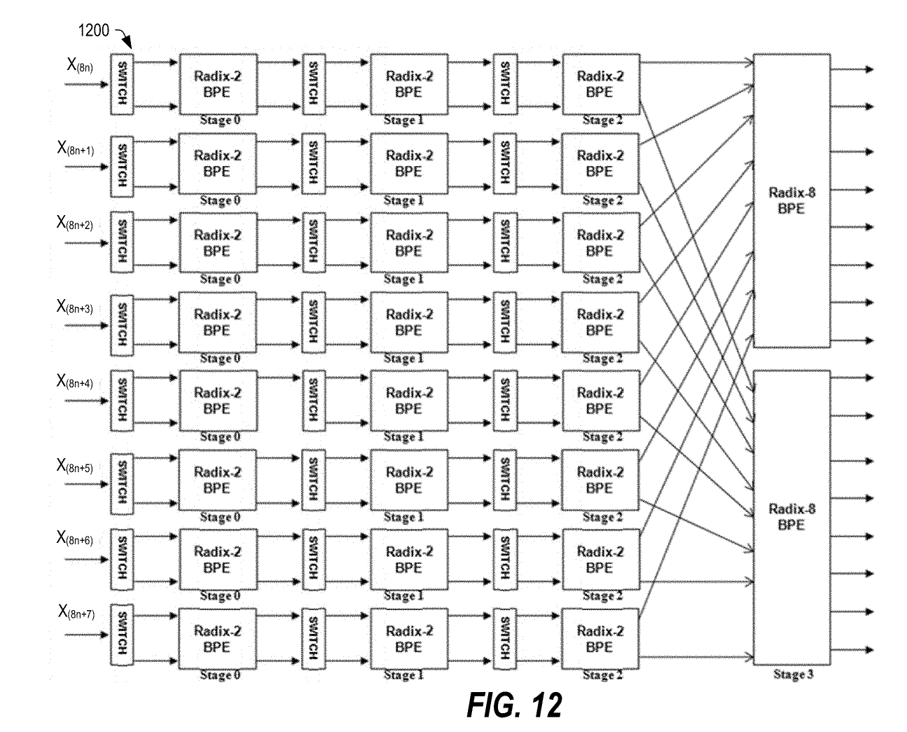

FIG. 12 depicts a multi-stage eight-parallel pipelined Radix-2 FFT structure 1200. The FFT structure 1200 includes four stages where the outputs of the pipelined stages are interchanged between the third stage (stage 2—Radix-2 stage) and the fourth stage (stage 3—Radix-8 stage).

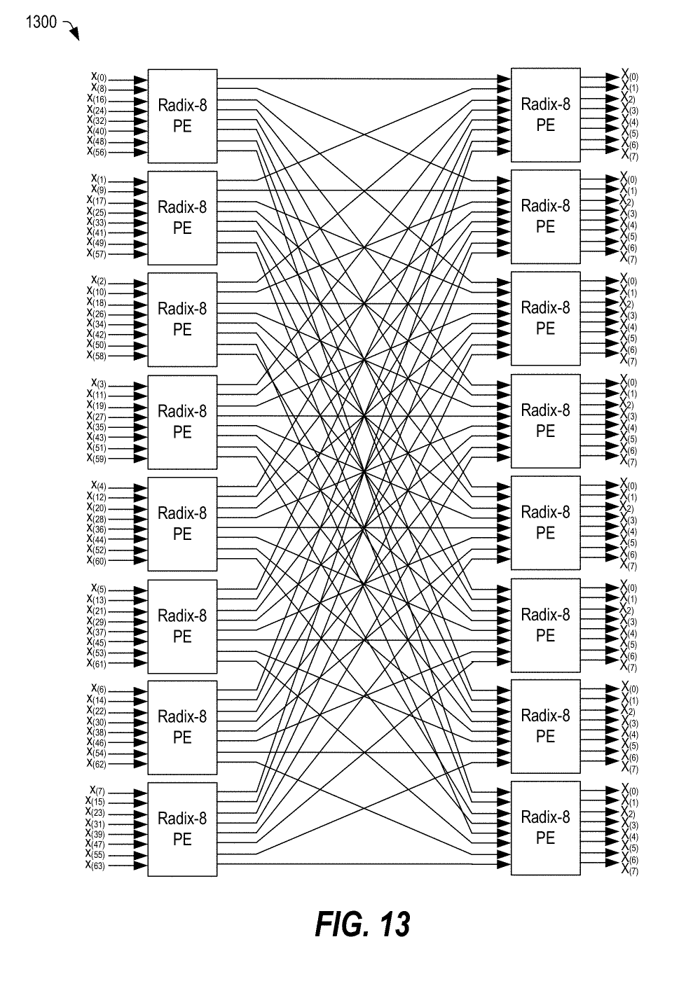

FIG. 13 depicts a multi-stage eight-parallel pipelined Radix-8 FFT structure 1300. In this example, the outputs of the pipelined stages are interchanged between the first stage (stage 0—Radix-8) and the second stage (stage 1—Radix-8).

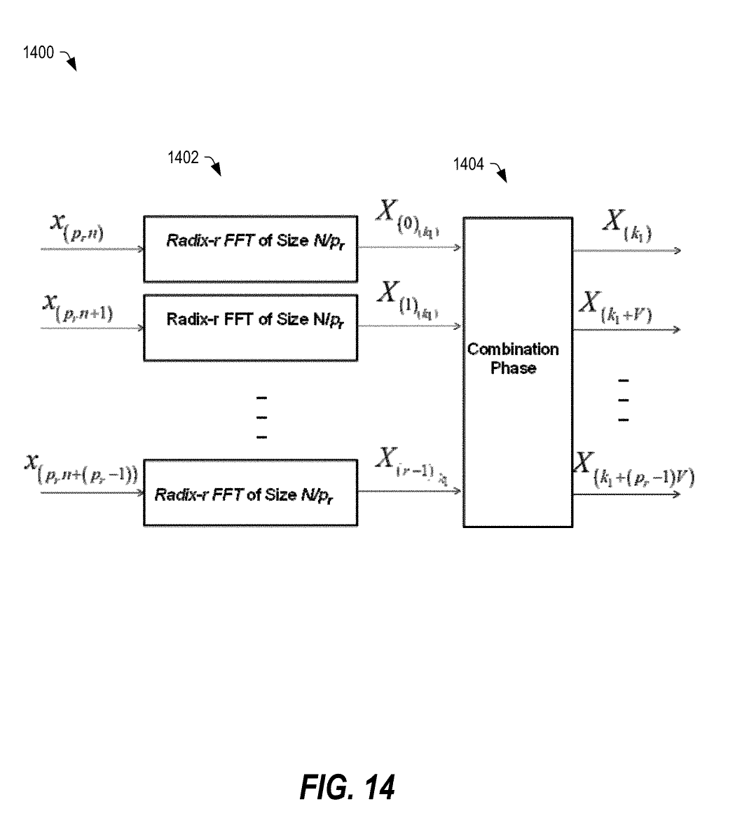

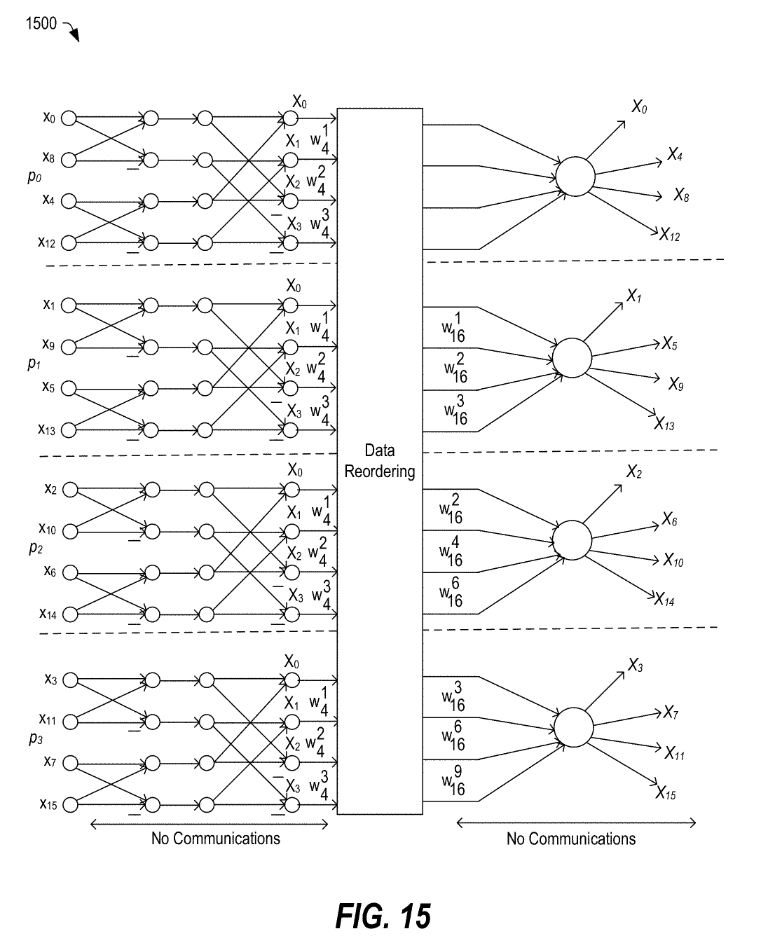

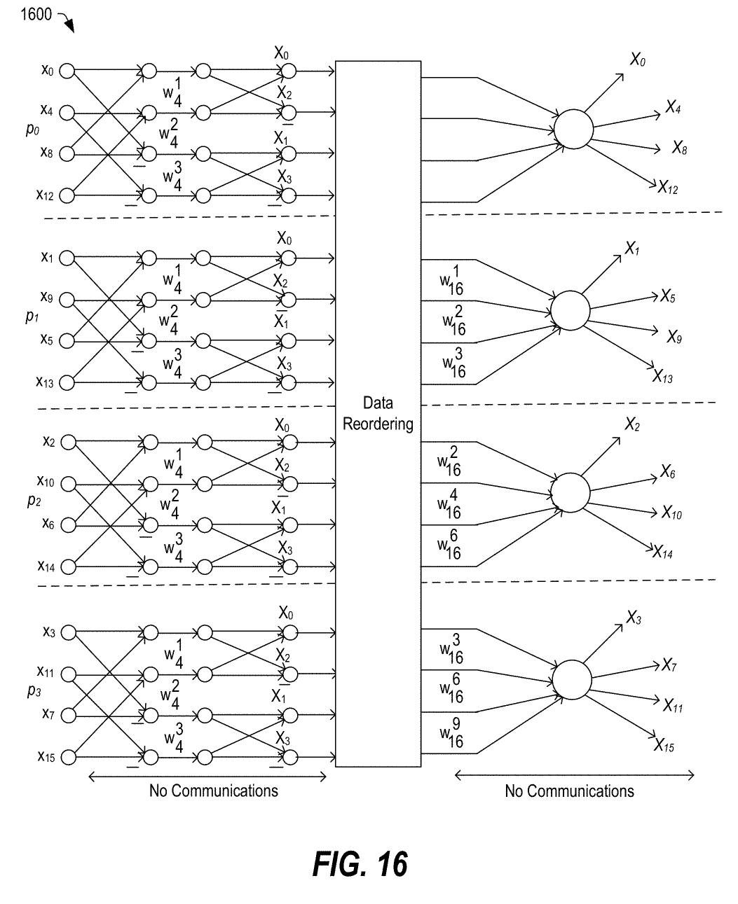

FIG. 14 depicts a generalized radix-r parallel structure 1400. The FFT structure 1400 includes a plurality of radix-r FFTs of size N/pᵣ (generally indicated at 1402) and a combination phase, generally indicated at 1404, which will require data reordering in order to parallelize the combination phase as shown in FIGS. 15 and 16. In this example, p FFTs of radix-r (of size N/p which is also a multiple of r) are executed on p parallel cores, and the results (X) are then combined on p parallel cores in order to obtain the required transform. In the FFT structure 1400, in the first part, no communication occurs between the p parallel cores and all cores execute the same FFT instructions of N/p FFT length. This FFT structure 1400 may be suitable for Single Instruction Multiple Data (SIMD) multicore systems.

Conceptually, embodiments of the methods and apparatus disclosed herein utilize the radixr FFT of size N composed of FFTs of size N/p with identical structures and a systematic means of accessing the same corresponding multiplier coefficients. For a single processor environment, the proposed method would result in a decrease in complexity for the complete FFT from N log(N) to N/p (log(N/p)+1/p) where the complexity cost of the combination phase that is parallelized over p core is N/p².

In certain embodiments, the precedence relations between the FFTs of size N/p in the radix-r FFT are such that the execution of p FFTs of size N/p in parallel is feasible during each FFT stage. If each FFT of size N/p is executed in parallel, each of the p parallel processors would be executing the same instruction simultaneously, which is very desirable for a single instruction, multiple data (SIMD) implementation.

FIG. 15 depicts a 16-point SFG of a DIT FFT parallel structure 1500. FFT parallel structure 1500 may be implemented in multiple stages within separate processor cores (P₀, P₁, P₂, and P₃), where data may be passed between threads of a given processor core, but not between processor cores, until a data reordering stage.

The precedence relations between the FFTs of size N/p in the radixr FFT are such that the execution of p FFTs of size N/p in parallel is feasible during each FFT stage. If each FFT of size N/p is executed in parallel, it means that each of the p parallel processors would always be executing the same instruction simultaneously, which is very desirable for SIMD implementation.

In an example, the one-dimensional (1D)-parallel FFT could be summarized as follows. First, the p data cores may be populated as shown in FIGS. 15 and 16, according to the following equation:

$$\begin{matrix}for ( k = 0 ; k < \frac{N}{P} ; ++ k ) \{ \\ {in}_{p} [ k ] = in [ P \times k + p ] ; \}\end{matrix} , \qquad ( 13 )$$

where the variable P represents the total number of cores and p=0, 1, P−1.

The FFT may be performed on each core of size N/P, where the data is well distributed locally for each core including its coefficients multipliers, and by doing so, each partial FFT will be performed in each core in the total absence of inter-cores communications. Further, the combination phase can be also performed in parallel over the p cores according to equation (11) above.

FIG. 16 depicts a 16-point SFG of a DIF FFT parallel structure 1600. Similar to the embodiment of FIG. 15, the FFT parallel structure 1600 may be implemented in multiple stages within separate processor cores (P₀, P₁, P₂, and P₃), where data may be passed between threads of a given processor core, but not between processor cores, until a data reordering stage.

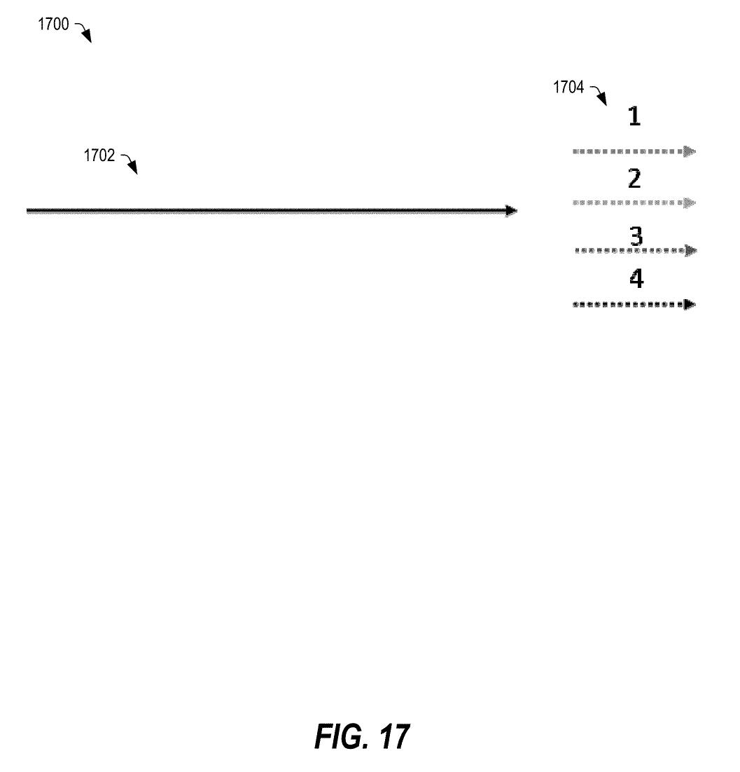

FIG. 17 depicts a conceptual diagram 1700 depicting population of the input data 1702 over four cores 1704. When the input data is parallelized over four cores, the data can be processed in parallel without delays due to message passing and with reduced delays due to memory accesses. Each of the r-parallel processors can execute the same instruction simultaneously.

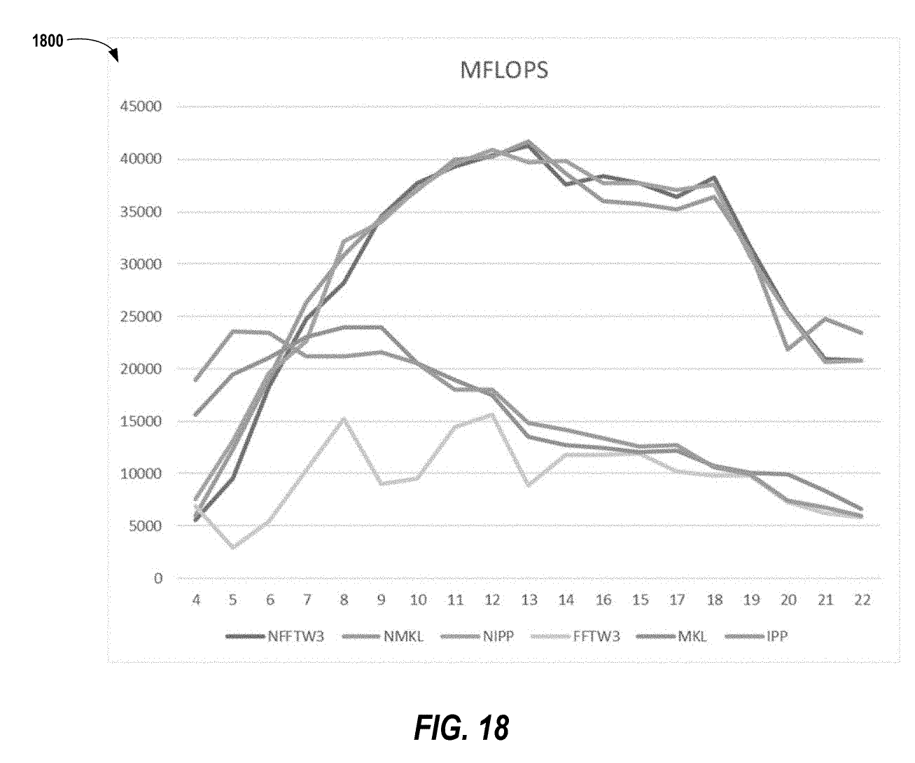

FIG. 18 depicts a graph 1800 of speed (in megaflops) versus a number of bits, showing the overall gain of speed. The graph 1800 depicts the speed in megaflops for a prior art FFTW3, MKL and IPP implementations as compared to that of the parallel multi-core NFFTW3, NMKL and NIPP implementations of the present disclosure.

The speed increase provided by the parallel multi-core implementation is particularly apparent as the number of the FFT's input size increases. This abnormal increase in speed can be attributed to the cache effects. In fact, the Core i7 can implement the shared memory paradigm. Each i7 core has a private memory of 64 kB and 256 kB for L1 and L2 caches, respectively. The 8 MB L3 cache is shared among the plurality of processing cores. All i7 core caches, in this particular implementation, included 64 kB cache lines (four complex double-precision numbers or eight complex single-precision numbers).

The serial FFTW algorithm running on a single core has to fill the input/output arrays of size N and the coefficient multipliers of size N/2 into the three levels caches of one core. By doing so, the hit rates of the L1 and L2 caches are decreased, which will increase the average memory access time (AMAT) for the three levels of cache, backed by DRAM. Similarly, the conventional Multi-threaded FFTW distributes randomly the input and the coefficients multipliers over the p cores. By doing so, the miss rates in the L1 and L2 caches will increase due to the fact that the required specific data and its corresponding multiplier needed by a specific core might be present in a different core. This needed multiplier translates into an increase of the average memory access time for the three levels of caches.

Contrarily, the embodiments of the apparatuses, systems, and methods can execute p FFTs of size N/p on p cores, where the combination phase is executed over p threads, offering a super-linear speedup. To parallelize the data over the p cores, the apparatuses, methods, and systems may fill the specific input/output arrays of size N/P and their coefficient multipliers of size N/(2×p) into the three levels caches of the specific core. This structure increases efficiently the hit rates of the L1 and L2 caches and decreases drastically the average memory access time for the three levels of cache, which translates into this abnormal speedup. In particular, the speedup is provided by the fact that the required specific data and its corresponding multiplier needed by a specific core are always present in the specific core.

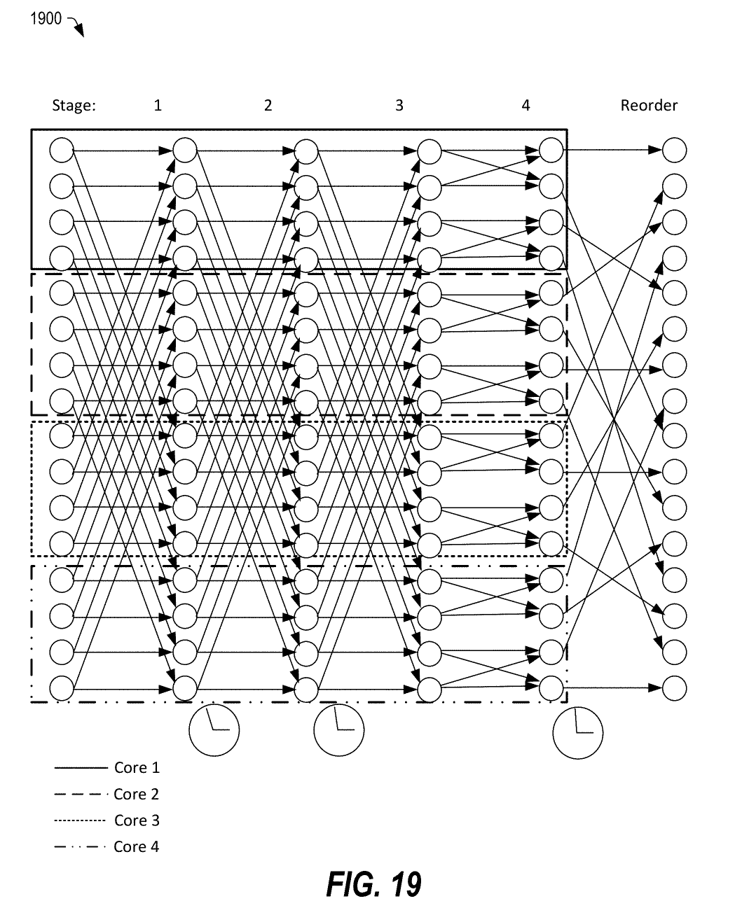

FIG. 19 depicts a conceptual SFG 1900 for a DIT FFT. In this example, the SFG 1900 shares coefficient data and data across processor cores in both the first and second stages, thereby increasing processing delays.

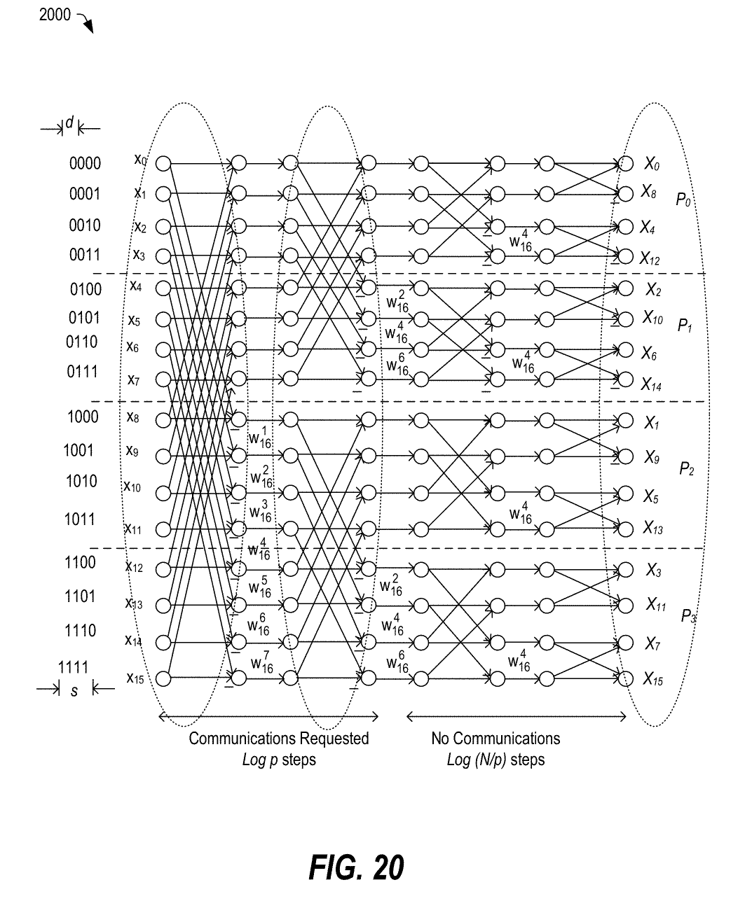

FIG. 20 depicts a conceptual SFG 2000 for a DIT FFT. In this example, communication occurs between the cores in the first and second stages, and then there is no inter-core communication in subsequent stages. However, the conceptual SFG 2000 of FIG. 20 depicts the drawbacks of conventional methods. In particular, communications between the processor cores may delay completion of the FFT computations because the calculation by one thread may delay processing of a next portion of the computation by another thread within a different core. Accordingly, the overall computation may be delayed due to the inter-core messages.

Embodiments of the methods and devices of the present disclosure improve the processing efficiency of an FFT computation by organizing the FFT calculation to reduce inter-core data passing. By constructing the FFT computations so that the cores are not dependent on one another for the output of one calculation to complete a next calculation. Rather, the component calculations may be performed by threads within the same core, thereby enhancing the throughput of the processor for a wide range of data processing computations. One possible example is described below with respect to FIG. 20.

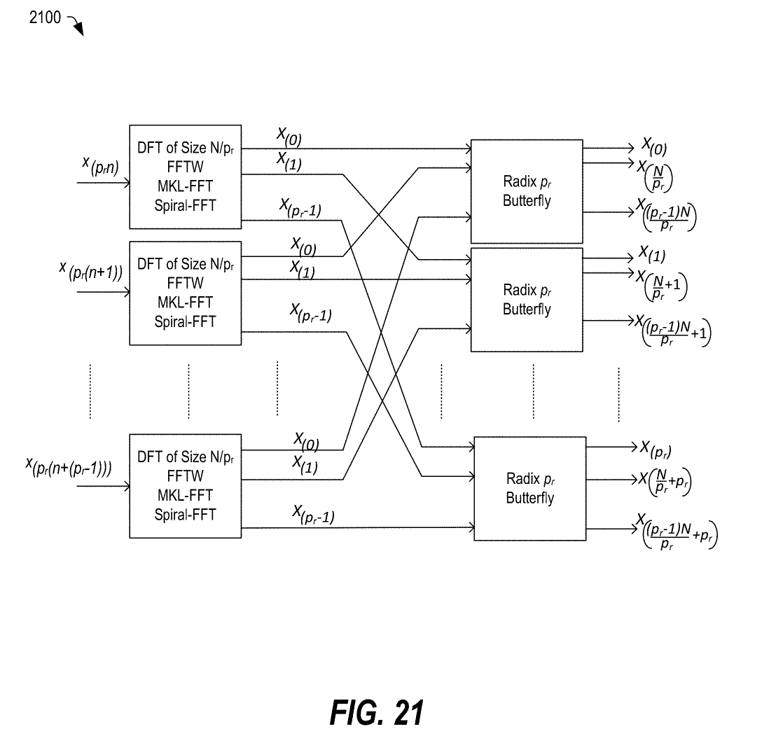

FIG. 21 depicts a one-dimensional FFT parallel structure 2100 with a parallelized combination phase, in accordance with certain embodiments of the present disclosure. To increase the performance, the structure 2100 is configured to parallelize the combination phase over p cores/threads, which is stipulated in equations (8), (9) and (10) above. By subdividing the computational load of the radix-p butterfly in the combination phase among the p cores, the output is determined according to the following equation:

X_{(c+qV)}=X₍₀₎_{_{(c)}}+w_{N}^{c}w_{N}^{qV}X₍ₜ₎_{_{(c)}}+L+w_{N}^{(p-1)c}w_{N}^{(p-1)qV}X₍ₚ₋₁₎_{_{(c)}} (14)

where c=0, 1, . . . , p−1 (p is the total number of cores/threads) and for v=0:p:V−1.

By doing so, the data reordering illustrated in FIGS. 15 and 16 can be eliminated completely. In this example, the input data (x) can be divided into a plurality of DFTs of size N/pr, which are then provided to the particular processor cores to perform the FFTs, in parallel. The outputs of the DFT blocks produce a plurality of Nth order FFTs, which are then provided to the processor cores to implement the radix-pr butterfly operations, in parallel. The DFTs may be implemented for a FFTW, a Math Kernel Library (MKL) FFT, a spiral FFT, other FFT implementations, or any combination thereof.

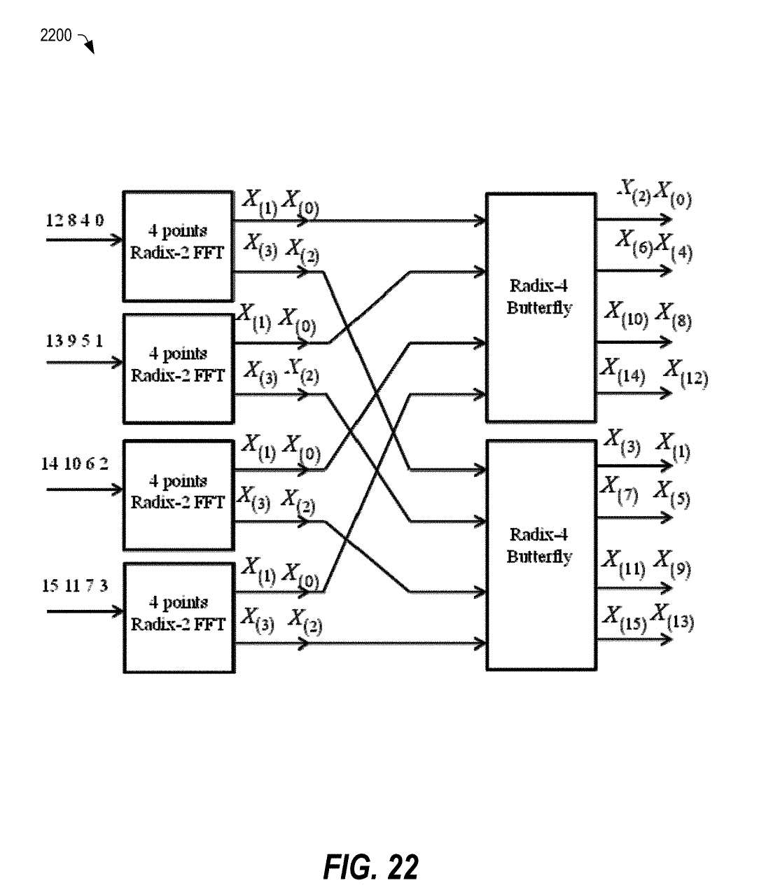

FIG. 22 depicts a block diagram of a four-parallel DIT FFTs (radix-2) 2200 on four cores where the results are combined with two radix-4 butterflies in order to compute a 16-points FFT, in accordance with certain embodiments of the present disclosure. The embodiment of FIG. 22 reveals the parallel model of a 16-points DFT. In this example, the input data are processed in parallel by four separate cores configured to implement a Radix-2 FFT to produce a plurality of four-point FFTs, which can be combined within two Radix-4 butterflies. The results of the parallel DIT FFTs (radix-2) are determined on four cores, and the results are combined with the two Radix-4 butterflies to compute a 16-points FFT.

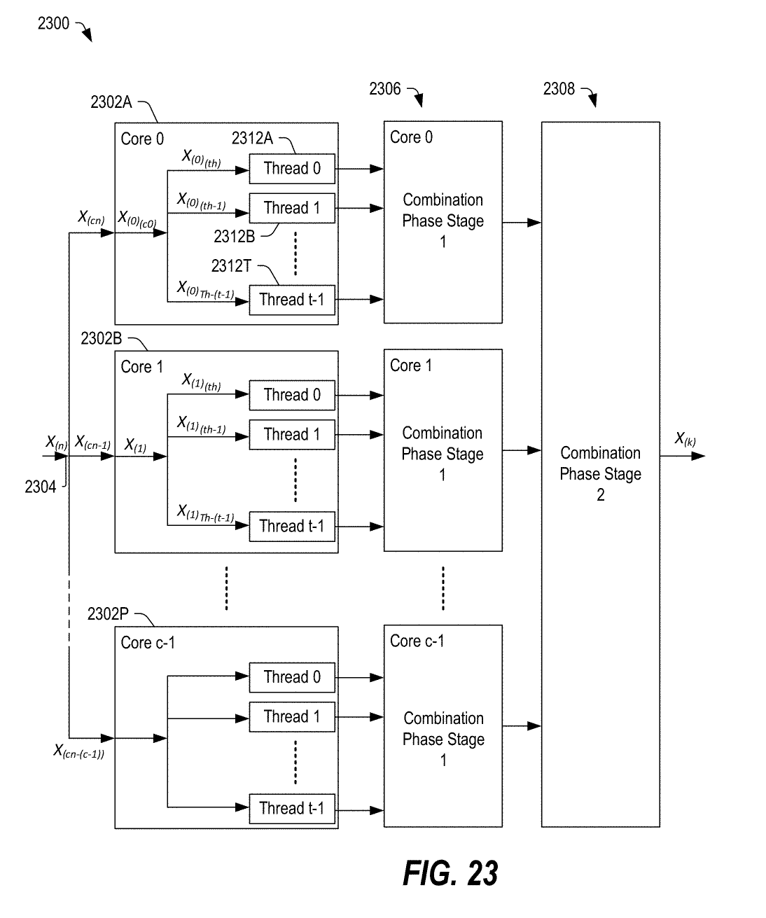

FIG. 23 depicts a block diagram of a multi-stage FFT parallel structure 2300, in accordance with certain embodiments of the present disclosure. In some embodiments, the multi-stage FFT parallel structure 2300 may be implemented on a processor circuit. The structure 2300 may include a plurality of cores 2302. Each core 2302 may be coupled to an input 2304 to receive at least a portion of the input data to be processed. Further, each core 2302 may provide an output to a first combination phase stage 2306. The first combination phase stage 2306 may provide a plurality of outputs to a second combination phase stage 2308, which has an output to provide a DFT (Xₖ) based on the input data (xₙ). In this example, each of the processor cores 2302A and 2302B through 2302P may include a plurality of threads 2312, such as processor threads 2312A and 2312B through 2312T. It should be understood that the apparatus may include any number of processor cores 2302, and each core 2302 may include any number of threads 2312. Other embodiments are also possible.

In the illustrated example, each core 2302 may be configured to process data in tₕ threads in parallel to produce a DFT output. The parallelized data on each core can be parallelized over the tₕ threads, yielding to a structure that could compute p×tₕ FFTs in parallel as shown in FIG. 23. As mentioned above, the input data of the partial FFT (x_{(p,n)}) are populated over t threads according to the following equation:

$$\begin{matrix}for ( k = 0 ; k < \frac{N}{Pt} ; ++ k ) \{ \\ {in}_{{p}_{r}} [ k ] = in [ t \times k + t ] ; \} \\ t = 0 , 1 , K , {t}_{h} - 1 \\ p = 0 , 1 , K , c - 1\end{matrix} , \qquad ( 15 )$$

The structure 2300 may be configured to execute the p FFTs of size N/p on p cores, where the first combination phase is also executed p×tₕ cores/threads, and the second combination phase is parallelized over p cores/threads.

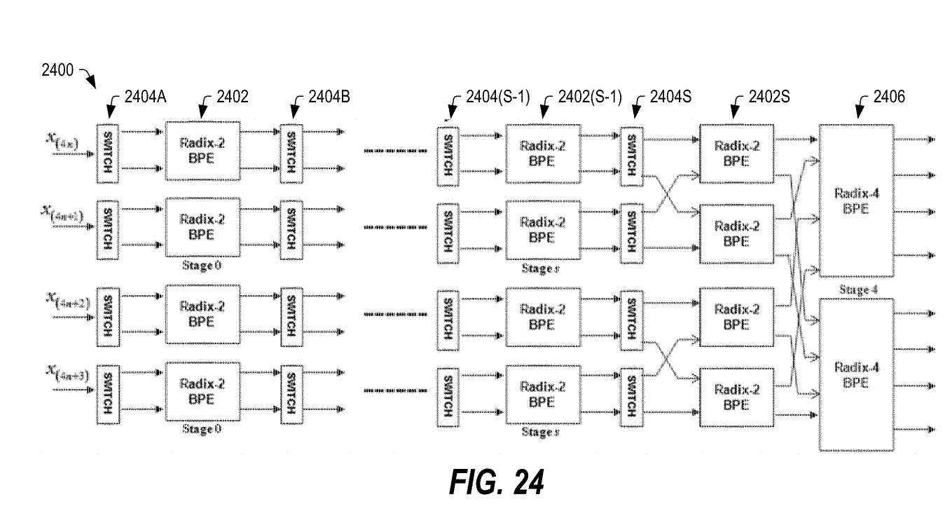

FIG. 24 depicts a block diagram of a system 2400 including two parallel Radix-2 pipelined block processing engines (BPEs) connected to two Radix-4 BPEs, in accordance with certain embodiments of the present disclosure. The system 2400 may include a plurality of Radix-2 BPE stages 2402, a plurality of switches 2404, and a Radix-4 BPE 2406. In this example, the first combination phase is parallelized over four cores and a plurality of threads per core. The second combination is parallelized over two cores and a plurality of threads. Other embodiments are also possible. By processing the partial FFTs within a selected processing core and without inter-core communications, the memory access overhead and the inter-core message passing overhead may be reduced, which may increase the overall speed.

The two-dimensional (2D) Fourier Transform is often used in image processing and petroleum seismic analysis, but may also be used in a variety of other contexts, such as in computational fluid dynamics, medical technology, multiple precision arithmetic and computational number theory applications, other applications, or any combination thereof. It is a similar to the usual Fourier Transform that is extended in two directions, where the most successful attempt to parallelize the 2D FFT is FFTW, where the parallelization process is accomplished by parallelizing the series of 1D FFT (columns and rows wise) over the p cores.

The definition of the 2D DFT is represented by:

$${X}_{( {k}_{1} , {k}_{2} )} = {\sum }_{{n}_{1} = 0}^{{N}_{1} - 1} {\sum }_{{n}_{2} = 0}^{{N}_{2} - 1} {x}_{( {n}_{1} , {n}_{2} )} {w}_{{N}_{1}}^{{n}_{1} {k}_{1}} {w}_{{N}_{2}}^{{n}_{2} {k}_{2}} \\ {k}_{1} ∈ [ 0 , {N}_{1} - 1 ] , {k}_{2} ∈ [ 0 , {N}_{2} - 1 ] , \qquad ( 16 )$$

where x₍ₙ_{₁}_{,n}_{₂}₎ is the input sequence, x₍ₖ_{₁}_{,k}_{₂}₎ is the output sequence, N₁×N₂ is the transform length and w_{N}_{₁}, w_{N}_{₂} are the Nth root of unity (w_{N}_{₁}=e^{-j2π/N}₁, w_{N}_{₂}=e^{-j2π/N}₂)

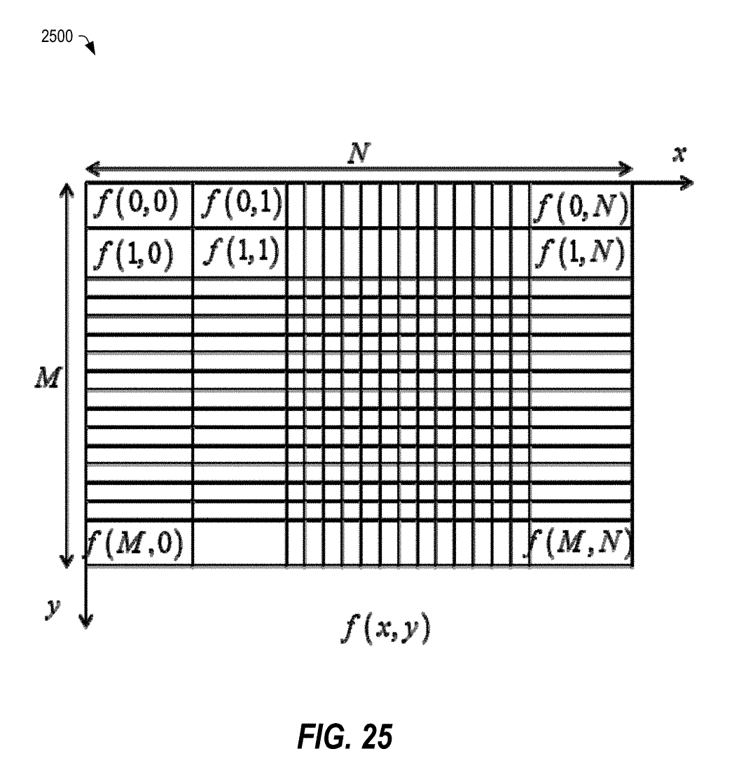

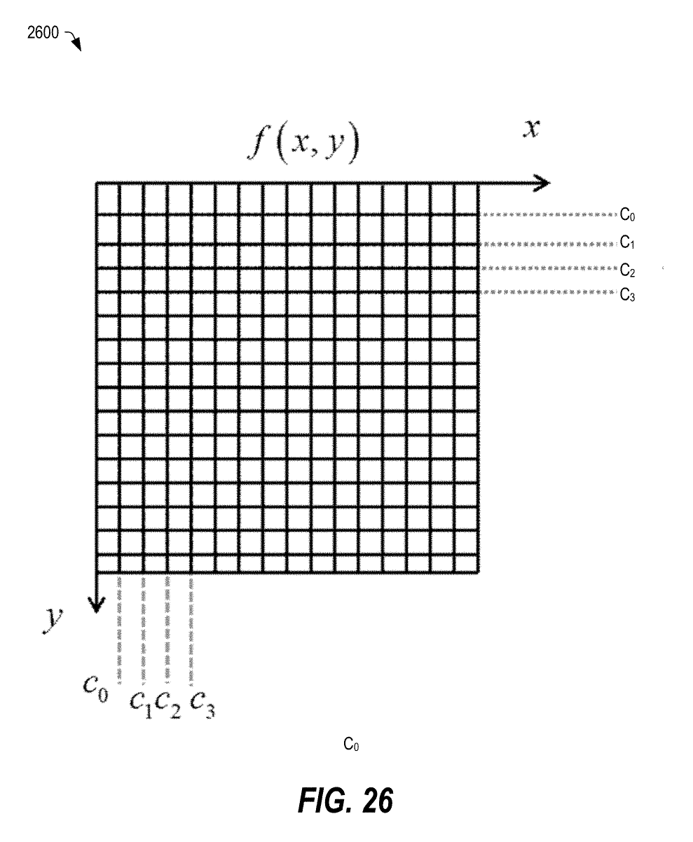

The parallelization process can be accomplished in three steps: a first step 1 1D FFT row-wise, where each processor executes sequentially 1D FFT in which the inter-processor communication is absent; a second step includes a row/column transposition of the matrix prior to executing FFT on columns because column elements are not stored in contiguous memory locations as shown in FIG. 25; and a third step includes 1D FFT column-wise FFTs as illustrated in FIG. 26.

FIG. 25 depicts a matrix 2500 showing storage of a complex two-dimensional matrix into memories.

FIG. 26 depicts a matrix 2600 showing parallelization of the two-dimensional FFT by parallelizing the series of 1D FFT (columns and rows wise) over four cores. The 2D FFT can be accomplished by parallelizing the series of 1D FFT (columns and rows wise) over the 4 cores.

The separation of the 2D FFT into series into series of 1D FFT is shown in the equation below:

$${X}_{( {k}_{1} , {k}_{2} )} = {\sum }_{{n}_{1} = 0}^{{N}_{1} - 1} {\sum }_{{n}_{2} = 0}^{{N}_{2} - 1} {x}_{( {n}_{1} , {n}_{2} )} {w}_{N}^{{n}_{1} {k}_{1}} {w}_{N}^{{n}_{2} {k}_{2}} = {\sum }_{{n}_{1} = 0}^{{N}_{1} - 1} {w}_{{N}_{1}}^{{n}_{1} {k}_{1}} {\sum }_{{n}_{2} = 0}^{{N}_{2} - 1} {x}_{( {n}_{1} , {n}_{2} )} {w}_{{N}_{2}}^{{n}_{2} {k}_{2}} = {\sum }_{{n}_{1} = 0}^{{N}_{1} - 1} {w}_{{N}_{1}}^{{n}_{1} {k}_{1}} ( {X}_{( {n}_{1} , {k}_{2} )} ) \\ {k}_{1} ∈ [ 0 , {N}_{1} - 1 ] , {k}_{2} ∈ [ 0 , {N}_{2} - 1 ] \\ {X}_{( {n}_{1} , {k}_{2} )} = {\sum }_{{n}_{2} = 0}^{{N}_{2} - 1} {x}_{( {n}_{1} , {n}_{2} )} {w}_{{N}_{2}}^{{n}_{2} {k}_{2}} \qquad ( 17 )$$

Thus, the 2D FFT has been transformed into N₁ 1D FFT of length N₂ (1D FFT on the N₁ rows) and into N₂ 1D FFT of length N₁ (1D FFT on the N₂ columns).

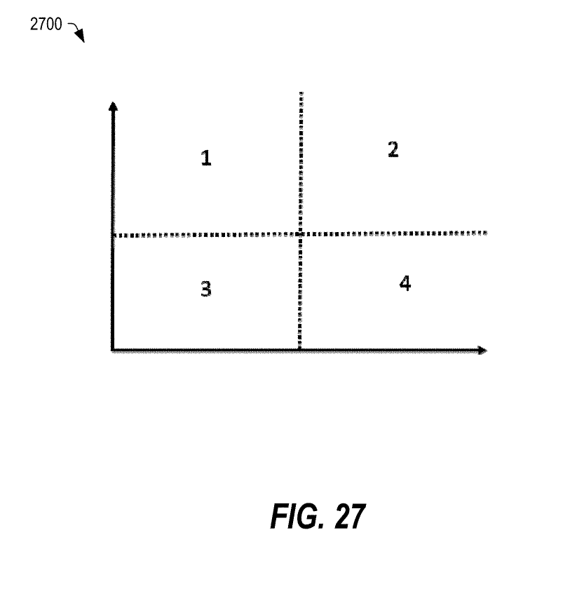

Embodiments of the parallel multi-dimensional FFT are described below with respect to FIG. 27 in accordance with certain embodiments of the present disclosure, in which the partitioning of the input data is similar to the 1D parallel FFT. In an example, Equation 15 can be rewritten as follows:

$$( 18 )$$

$${X}_{( {k}_{1} , {k}_{2} )} = [ \begin{matrix}{\sum }_{{n}_{1} = 0}^{\frac{{N}_{1}}{p} - 1} {\sum }_{{n}_{2} = 0}^{\frac{{N}_{2}}{p} - 1} {x}_{( {pn}_{1} , {pn}_{2} )} {w}_{{N}_{1}}^{{pn}_{1} {k}_{1}} {w}_{{N}_{2}}^{{pn}_{2} {k}_{2}} + \\ {\sum }_{{n}_{1} = 0}^{\frac{{N}_{1}}{p} - 1} {\sum }_{{n}_{2} = 0}^{\frac{{N}_{2}}{p} - 1} {x}_{( {pn}_{1} + 1 {pn}_{2} + 1 )} {w}_{{N}_{1}}^{( {pn}_{1} + 1 ) {k}_{1}} {w}_{{N}_{2}}^{( {pn}_{2} + 1 ) {k}_{2}} + L + \\ {\sum }_{{n}_{1} = 0}^{\frac{{N}_{1}}{p} - 1} {\sum }_{{n}_{2} = 0}^{\frac{{N}_{2}}{p} - 1} {x}_{( {pn}_{1} + ( P - 1 ) , {pn}_{2} + ( P - 1 ) )} {w}_{{N}_{1}}^{( {pn}_{1} + ( P - 1 ) ) {k}_{1}} {w}_{{N}_{2}}^{( {pn}_{2} + ( P - 1 ) ) {k}_{2}}\end{matrix} ] , \\ {k}_{1} ∈ [ 0 , {N}_{1} - 1 ] , {k}_{2} ∈ [ 0 , {N}_{2} - 1 ]$$

$$( 19 )$$

$${X}_{( {k}_{1} , {k}_{2} )} = [ \begin{matrix}{\sum }_{{n}_{1} = 0}^{\frac{{N}_{1}}{p} - 1} {\sum }_{{n}_{2} = 0}^{\frac{{N}_{2}}{p} - 1} {x}_{( {pn}_{1} , {pn}_{2} )} {w}_{\frac{{N}_{1}}{p}}^{{n}_{1} {k}_{1}} {w}_{\frac{{N}_{2}}{p}}^{{n}_{2} {k}_{2}} + \\ {w}_{{N}_{1}}^{{k}_{1}} {w}_{{N}_{2}}^{{k}_{2}} {\sum }_{{n}_{1} = 0}^{\frac{{N}_{1}}{p} - 1} {\sum }_{{n}_{2} = 0}^{\frac{{N}_{2}}{p} - 1} {x}_{( {pn}_{1} + 1 {pn}_{2} + 1 )} {w}_{\frac{{N}_{1}}{p}}^{{n}_{1} {k}_{1}} {w}_{\frac{{N}_{2}}{p}}^{{n}_{2} {k}_{2}} + L + \\ {w}_{{N}_{1}}^{( P - 1 ) {k}_{1}} {w}_{{N}_{2}}^{( P - 1 ) {k}_{2}} {\sum }_{{n}_{1} = 0}^{\frac{{N}_{1}}{p} - 1} {\sum }_{{n}_{2} = 0}^{\frac{{N}_{2}}{p} - 1} {x}_{( {pn}_{1} + ( P - 1 ) , {pn}_{2} + ( P - 1 ) )} {w}_{\frac{{N}_{1}}{p}}^{{n}_{1} {k}_{1}} {w}_{\frac{{N}_{2}}{p}}^{{n}_{2} + {k}_{2}}\end{matrix} ] , \\ {k}_{1} ∈ [ 0 , {N}_{1} - 1 ] , {k}_{2} ∈ [ 0 , {N}_{2} - 1 ]$$

By defining v₁=0, 1, . . . , V₁−1, v₂=0, 1, . . . , V₂−1 and q=0, 1, . . . , P−1 where V₁=N₁/p and V₂=N₂/p, the variables k₁ and k₂ can be expressed as follows:

k₁=v₁+qV₁

k₂=v₂+qV₂ (20)

As a result, equation (19) could be expressed as follows:

$$( 21 )$$

$${X}_{( {v}_{1} + {qV}_{1} , {v}_{2} + {qV}_{2} )} = [ \begin{matrix}{\sum }_{{n}_{1} = 0}^{{V}_{1} - 1} {\sum }_{{n}_{2} = 0}^{{V}_{2} - 1} {x}_{( {pn}_{1} , {pn}_{2} )} {w}_{{V}_{1}}^{{n}_{1} ( {v}_{1} + {qV}_{1} )} {w}_{{V}_{2}}^{{n}_{2} ( {v}_{2} + {qV}_{2} )} + \\ {w}_{{N}_{1}}^{( {v}_{1} + {qV}_{1} )} {w}_{{N}_{2}}^{( {v}_{2} + {qV}_{2} )} {\sum }_{{n}_{1} = 0}^{{V}_{1} - 1} {\sum }_{{n}_{2} = 0}^{{V}_{2} - 1} {x}_{( {pn}_{1} + 1 , {pn}_{2} + 1 )} {w}_{{V}_{1}}^{{n}_{1} ( {v}_{1} + {qV}_{1} )} {w}_{{V}_{2}}^{{n}_{2} ( {v}_{2} + {qV}_{2} )} + \\ L + {w}_{{N}_{1}}^{( P - 1 ) ( {v}_{1} + {qV}_{1} )} {w}_{{N}_{2}}^{( P - 1 ) ( {v}_{2} + {qV}_{2} )} {\sum }_{{n}_{1} = 0}^{{V}_{1} - 1} {\sum }_{{n}_{2} = 0}^{{V}_{2} - 1} {x}_{( {pn}_{1} + ( P - 1 ) , {pn}_{2} + ( P - 1 ) )} {w}_{{V}_{1}}^{{n}_{1} ( {v}_{1} + {qV}_{1} )} {w}_{{V}_{2}}^{{n}_{2} ( {v}_{2} + {qV}_{2} )}\end{matrix} ]$$

$${v}_{1} ∈ [ 0 , {V}_{1} - 1 ] , {v}_{2} ∈ [ 0 , {V}_{2} - 1 ]$$

Considering that the variable (w) in equation (21) may be equal to one, the values may be determined as follows:

w_{V}_{₁}ⁿ^{₁}^{qV}^{₁}=(w_{V}_{₁}^{V}^{₁})ⁿ^{₁}^{q}=(1)ⁿ^{₁}^{q}=1,

w_{V}_{₂}ⁿ^{₂}^{qV}^{₂}=(w_{V}_{₂}^{V}^{₂})ⁿ^{₂}^{q}=(2)ⁿ^{₂}^{q}=1 (22)

Therefore, we can rewrite equation (21) as follows:

$$( 23 )$$

$${X}_{( {v}_{1} + {qV}_{1} , {v}_{2} + {qV}_{2} )} = [ \begin{matrix}{\sum }_{{n}_{1} = 0}^{{V}_{1} - 1} {\sum }_{{n}_{2} = 0}^{{V}_{2} - 1} {x}_{( {pn}_{1} , {pn}_{2} )} {w}_{{V}_{1}}^{{n}_{1} {v}_{1}} {w}_{{V}_{2}}^{{n}_{2} {v}_{2}} + \\ {w}_{{N}_{1}}^{( {v}_{1} + {qV}_{1} )} {w}_{{N}_{2}}^{( {v}_{2} + {qV}_{2} )} {\sum }_{{n}_{1} = 0}^{{V}_{1} - 1} {\sum }_{{n}_{2} = 0}^{{V}_{2} - 1} {x}_{( {pn}_{1} + 1 , {pn}_{2} + 1 )} {w}_{{V}_{1}}^{{n}_{1} {v}_{1}} {w}_{{V}_{2}}^{{n}_{2} {v}_{2}} + \\ L + {w}_{{N}_{1}}^{( P - 1 ) ( {v}_{1} + {qV}_{1} )} {w}_{{N}_{2}}^{( P - 1 ) ( {v}_{2} + {qV}_{2} )} {\sum }_{{n}_{1} = 0}^{{V}_{1} - 1} {\sum }_{{n}_{2} = 0}^{{V}_{2} - 1} {x}_{( {pn}_{1} + ( P - 1 ) , {pn}_{2} + ( P - 1 ) )} {w}_{{V}_{1}}^{{n}_{1} {v}_{1}} {w}_{{V}_{2}}^{{n}_{2} {v}_{2}}\end{matrix} ] . \\ {v}_{1} ∈ [ 0 , {V}_{1} - 1 ] , {v}_{2} ∈ [ 0 , {V}_{2} - 1 ]$$

If X₍ₖ_{₁}_{,k}_{₂}₎ is the N₁^{th}×N₂^{th} order 2D-Fourier transform

$${\sum }_{{n}_{1} = 0}^{{N}_{1} - 1} {\sum }_{{n}_{2} = 0}^{{N}_{2} - 1} {x}_{( {n}_{1} , {n}_{2} )} {w}_{N}^{{n}_{1} {k}_{1}} {w}_{N}^{{n}_{2} {k}_{2}}$$

then,

$${X}_{{( 0 )}_{( {v}_{1} , {v}_{2} )}} , {X}_{{( 1 )}_{( {v}_{1} , {v}_{2} )}} , … and {X}_{{( p - 1 )}_{( {v}_{1} , {v}_{2} )}}$$

will be the N₁^{th}/P×N₂^{th}/P order Fourier transforms given respectively by the following expressions

$${\sum }_{{n}_{1} = 0}^{{V}_{1} - 1} {\sum }_{{n}_{2} = 0}^{{V}_{2} - 1} {x}_{( {pn}_{1} , {pn}_{2} )} {w}_{{V}_{1}}^{{n}_{1} {v}_{1}} {w}_{{V}_{2}}^{{n}_{2} {v}_{2}} , \\ {\sum }_{{n}_{1} = 0}^{{V}_{1} - 1} {\sum }_{{n}_{2} = 0}^{{V}_{2} - 1} {x}_{( {pn}_{1} + 1 , {pn}_{2} + 1 )} {w}_{{V}_{1}}^{{n}_{1} {v}_{1}} {w}_{{V}_{2}}^{{n}_{2} {v}_{2}} , … and$$

$${\sum }_{{n}_{1} = 0}^{{V}_{1} - 1} {\sum }_{{n}_{2} = 0}^{{V}_{2} - 1} {x}_{( {pn}_{1} + ( P - 1 ) , {pn}_{2} + ( P - 1 ) )} {w}_{{V}_{1}}^{{n}_{1} {v}_{1}} {w}_{{V}_{2}}^{{n}_{2} {v}_{2}} .$$

Based on the above assumption, equation (23) can be rewritten as follows:

$${X}_{( {v}_{1} + {qV}_{1} , {v}_{2} + {qV}_{2} )} = {X}_{{( 0 )}_{( {v}_{1} , {v}_{2} )}} + ( {w}_{{N}_{1}}^{{v}_{1}} {w}_{{N}_{1}}^{{qV}_{1}} {w}_{{N}_{2}}^{{v}_{2}} {w}_{{N}_{2}}^{{qV}_{2}} ) {X}_{{( 1 )}_{( {v}_{1} , {v}_{2} )}} + L + ( {w}_{{N}_{1}}^{( P - 1 ) {v}_{1}} {w}_{{N}_{1}}^{( P - 1 ) {pV}_{1}} {w}_{{N}_{2}}^{( P - 1 ) {v}_{2}} {w}_{{N}_{2}}^{( P - 1 ) {qV}_{2}} ) {X}_{{( p - 1 )}_{( {v}_{1} , {v}_{2} )}} \qquad ( 24 )$$

Equation (24) can be expanded as follows:

$$\begin{matrix}{X}_{( {k}_{1} , {k}_{2} )} = [ \begin{matrix}{X}_{( {v}_{1} , {v}_{2} )} \\ {X}_{( {v}_{1} + {V}_{1} , {v}_{2} + {V}_{2} )} \\ M \\ {X}_{( {v}_{1} + ( p - 1 ) {V}_{1} , {v}_{2} + ( p - 1 ) {V}_{2} )}\end{matrix} ] \\ = [ \begin{matrix}[ \begin{matrix}{w}_{{N}_{1}}^{0} & {w}_{{N}_{1}}^{0} & L & {w}_{{N}_{1}}^{0} \\ {w}_{{N}_{1}}^{0} & {w}_{{N}_{1}}^{\frac{{N}_{1}}{p}} & L & {w}_{{N}_{1}}^{\frac{( p - 1 ) {N}_{1}}{p}} \\ M & M & O & M \\ {w}_{{N}_{1}}^{0} & {w}_{{N}_{1}}^{\frac{( p - 1 ) {N}_{1}}{p}} & L & {w}_{{N}_{1}}^{\frac{{( p - 1 )}^{2} {N}_{1}}{p}}\end{matrix} ] \times [ \begin{matrix}{w}_{{N}_{1}}^{0} & 0 & L & 0 \\ 0 & {w}_{{N}_{1}}^{{v}_{1}} & 0 & 0 \\ M & M & O & M \\ 0 & 0 & L & {w}_{{N}_{1}}^{( p - 1 ) {v}_{1}}\end{matrix} ] \times \\ [ \begin{matrix}{w}_{{N}_{2}}^{0} & {w}_{{N}_{2}}^{0} & L & {w}_{{N}_{2}}^{0} \\ {w}_{{N}_{2}}^{0} & {w}_{{N}_{2}}^{\frac{{N}_{2}}{p}} & L & {w}_{{N}_{2}}^{\frac{( p - 1 ) {N}_{2}}{p}} \\ M & M & O & M \\ {w}_{{N}_{2}}^{0} & {w}_{{N}_{2}}^{\frac{( p - 1 ) {N}_{2}}{p}} & L & {w}_{{N}_{2}}^{\frac{{( p - 1 )}^{2} {N}_{2}}{p}}\end{matrix} ] \times [ \begin{matrix}{w}_{{N}_{2}}^{0} & 0 & L & 0 \\ 0 & {w}_{{N}_{2}}^{{v}_{2}} & 0 & 0 \\ M & M & O & M \\ 0 & 0 & L & {w}_{{N}_{2}}^{( p - 1 ) {v}_{2}}\end{matrix} ] \times \\ [ \begin{matrix}{X}_{{( 0 )}_{( {v}_{1} , {v}_{2} )}} \\ {X}_{{( 1 )}_{( {v}_{1} , {v}_{2} )}} \\ M \\ {X}_{{( p - 1 )}_{( {v}_{1} , {v}_{2} )}}\end{matrix} ]\end{matrix} ]\end{matrix} \qquad ( 25 )$$

In equation (25), the term (X(k1, k2)) can be represented in the k₂ dimension according to the following equation:

$$\begin{matrix}{X}_{( {k}_{1} , {k}_{2} )} = [ \begin{matrix}{X}_{( {v}_{1} , {k}_{2} )} \\ {X}_{( {v}_{1} + {V}_{1} , {k}_{2} )} \\ M \\ {X}_{( {v}_{1} + ( p - 1 ) {V}_{1} , {k}_{2} )}\end{matrix} ] \\ = [ \begin{matrix}{w}_{{N}_{2}}^{0} & {w}_{{N}_{2}}^{0} & L & {w}_{{N}_{2}}^{0} \\ {w}_{{N}_{2}}^{0} & {w}_{{N}_{2}}^{\frac{{N}_{2}}{p}} & L & {w}_{{N}_{2}}^{\frac{( p - 1 ) {N}_{2}}{p}} \\ M & M & O & M \\ {w}_{{N}_{2}}^{0} & {w}_{{N}_{2}}^{\frac{( p - 1 ) {N}_{2}}{p}} & L & {w}_{{N}_{2}}^{\frac{{( p - 1 )}^{2} {N}_{21}}{p}}\end{matrix} ] \times [ \begin{matrix}{w}_{{N}_{2}}^{0} & 0 & L & 0 \\ 0 & {w}_{{N}_{2}}^{{v}_{2}} & 0 & 0 \\ M & M & O & M \\ 0 & 0 & L & {w}_{{N}_{2}}^{( p - 1 ) {v}_{2}}\end{matrix} ] \times [ \begin{matrix}{X}_{{( 0 )}_{( {v}_{1} , {v}_{2} )}} \\ {X}_{{( 1 )}_{( {v}_{1} , {v}_{2} )}} \\ M \\ {X}_{{( p - 1 )}_{( {v}_{1} , {v}_{2} )}}\end{matrix} ]\end{matrix} \qquad ( 27 )$$

Further, in equation (25). the term (X(k1, k2)) can be represented in the k₁ dimension according to the following equation

$$\begin{matrix}{X}_{( {k}_{1} , {k}_{2} )} = [ \begin{matrix}{X}_{( {v}_{1} , {k}_{2} )} \\ {X}_{( {v}_{1} + {V}_{1} , {k}_{2} )} \\ M \\ {X}_{( {v}_{1} + ( p - 1 ) {V}_{1} , {k}_{2} )}\end{matrix} ] \\ = [ \begin{matrix}{w}_{{N}_{1}}^{0} & {w}_{{N}_{1}}^{0} & L & {w}_{{N}_{1}}^{0} \\ {w}_{{N}_{1}}^{0} & {w}_{{N}_{1}}^{\frac{{N}_{1}}{p}} & L & {w}_{{N}_{1}}^{\frac{( p - 1 ) {N}_{1}}{p}} \\ M & M & O & M \\ {w}_{{N}_{1}}^{0} & {w}_{{N}_{1}}^{\frac{( p - 1 ) {N}_{1}}{p}} & L & {w}_{{N}_{1}}^{\frac{{( p - 1 )}^{2} {N}_{1}}{p}}\end{matrix} ] \times [ \begin{matrix}{w}_{{N}_{1}}^{0} & 0 & L & 0 \\ 0 & {w}_{{N}_{1}}^{{v}_{1}} & 0 & 0 \\ M & M & O & M \\ 0 & 0 & L & {w}_{{N}_{1}}^{( p - 1 ) {v}_{1}}\end{matrix} ] \times [ \begin{matrix}{X}_{{( 0 )}_{( {v}_{1} , {v}_{2} )}} \\ {X}_{{( 1 )}_{( {v}_{1} , {v}_{2} )}} \\ M \\ {X}_{{( p - 1 )}_{( {v}_{1} , {v}_{2} )}}\end{matrix} ]\end{matrix} \qquad ( 28 )$$

This proposition is based on partitioning of the 2D input data into p 2d input data as shown in FIG. 27.

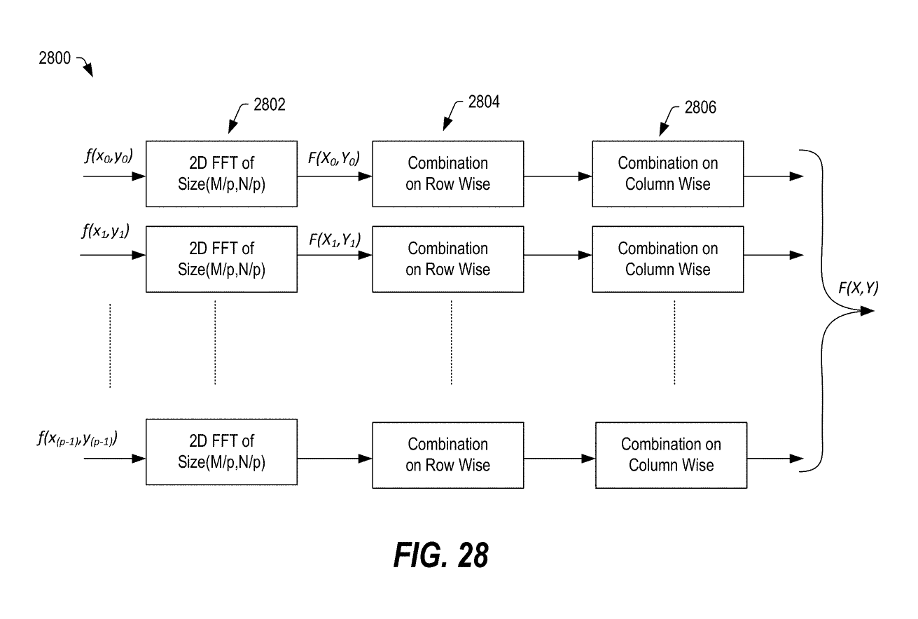

FIG. 27 depicts a graph 2700 representing a two-dimensional parallelization process over four cores, in accordance with certain embodiments of the present disclosure. The graph 2700 depicts four matrices that can be processed as 2D input data across four processing cores. Then, a combination phase on the column/row is used to obtain the 2D transform, as depicted in FIG. 28.

FIG. 28 depicts a block diagram of a two-dimensional FFT parallel structure 2800 with parallelized combination phase, in accordance with certain embodiments of the present disclosure. The structure 2800 includes a plurality of processor cores, generally indicated at 2802, each of which can process a 2D input matrix to determine a 2D FFT of size (M/p, N/p). Further, the structure 2800 includes a combination phase 2804 (row-wise) and a combination phase 2806 (column-wise) to produce the DFT output (F (X,Y)).

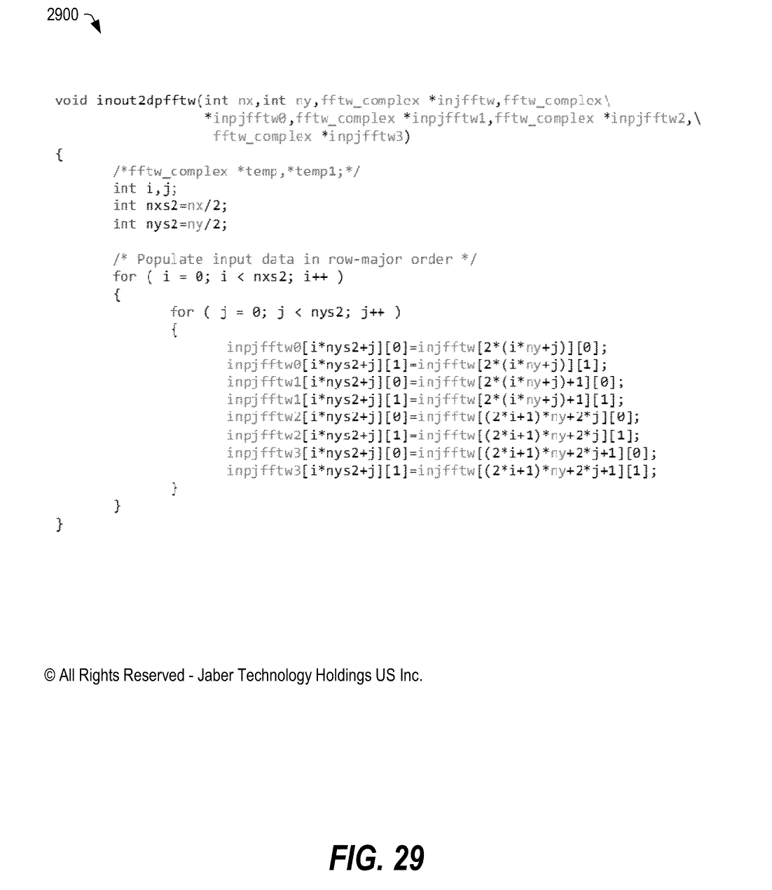

FIG. 29 depicts MATLAB source code 2900 illustrating a two-dimensional FFT address generator, in accordance with certain embodiments of the present disclosure. The source code 2900 subdivides the input data stream into four regions that can be used for a 2D parallel structure. According to the source code 2900, the input data is written to memory according to the calculations depicted in the nested “for” loops. The source code 2900 can be used to subdivide the input data stream for parallelized 2D FFTW3 processing across four multi-threaded cores.

The definition of the 3D DFT can be represented as follows:

$${X}_{( {k}_{1} , {k}_{2} , {k}_{3} )} = {\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {n}_{2} , {n}_{3} )} {w}_{{N}_{1}}^{{n}_{1} {k}_{1}} {w}_{{N}_{2}}^{{n}_{2} {k}_{2}} {w}_{{N}_{3}}^{{n}_{3} {k}_{3}} \\ {k}_{1} ∈ [ 0 , {N}_{1} - 1 ] , {k}_{2} ∈ [ 0 , {N}_{2} - 1 ] , {k}_{3} ∈ [ 0 , {N}_{3} - 1 ] . \qquad ( 29 )$$

The 3D FFT can be separated into a series of 2D FFTs according to the following equation:

$$\begin{matrix}{X}_{( {k}_{1} , {k}_{2} , {k}_{3} )} = {\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {n}_{2} , {n}_{3} )} {w}_{{N}_{1}}^{{n}_{1} {k}_{1}} {w}_{{N}_{2}}^{{n}_{2} {k}_{2}} {w}_{{N}_{3}}^{{n}_{3} {k}_{3}} \\ = {\sum }_{{n}_{1} = 0}^{{N}_{1} - 1} {w}_{{N}_{1}}^{{n}_{1} {k}_{1}} {\sum }_{{n}_{2} = 0}^{{N}_{2} - 1} {\sum }_{{n}_{3} = 0}^{{N}_{3} - 1} {x}_{( {n}_{1} , {n}_{2} , {n}_{3} )} {w}_{{N}_{2}}^{{n}_{2} {k}_{2}} {w}_{{N}_{3}}^{{n}_{3} {k}_{3}} \\ = {\sum }_{{n}_{1} = 0}^{{N}_{1} - 1} {w}_{{N}_{1}}^{{n}_{1} {k}_{1}} ( {X}_{( {n}_{1} , {k}_{2} , {k}_{3} )} )\end{matrix} \\ {k}_{1} ∈ [ 0 , {N}_{1} - 1 ] , {k}_{2} ∈ [ 0 , {N}_{2} - 1 ] , {k}_{3} ∈ [ 0 , {N}_{3} - 1 ] \\ {X}_{( {n}_{1} , {k}_{2} , {k}_{3} )} = {\sum }_{{n}_{2} = 0}^{{N}_{2} - 1} {\sum }_{{n}_{3} = 0}^{{N}_{3} - 1} {x}_{( {n}_{1} , {n}_{2} , {n}_{3} )} {w}_{{N}_{2}}^{{n}_{2} {k}_{2}} {w}_{{N}_{3}}^{{n}_{3} {k}_{3}} \qquad ( 30 )$$

By applying equation (30), the 3D FFT has been transformed into N₁ 2D FFTs of length N₂×N₃ 2 D FFT. In some embodiments, the 3D FFT may be parallelized by assigning N_{z}/P planes to each processor as shown in FIG. 38.

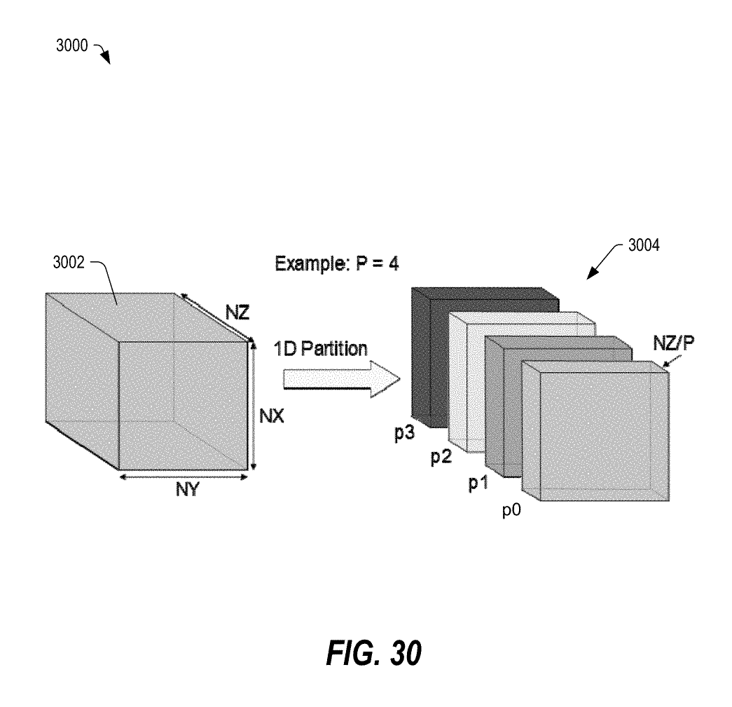

FIG. 30 shows a block diagram of a three-dimensional partition over four cores, as generally indicated 3000, in accordance with certain embodiments of the present disclosure. In FIG. 30, a 3D block of data 3002 is shown that represents a data cube or 3D matrix of data of size N××NY×NZ. The 3D block of data 3002 may be partitioned into four 2D data sets, generally indicated as 3004. The four 2D data sets may be assigned to a selected processor core, one for each processor core (p0 to p3).

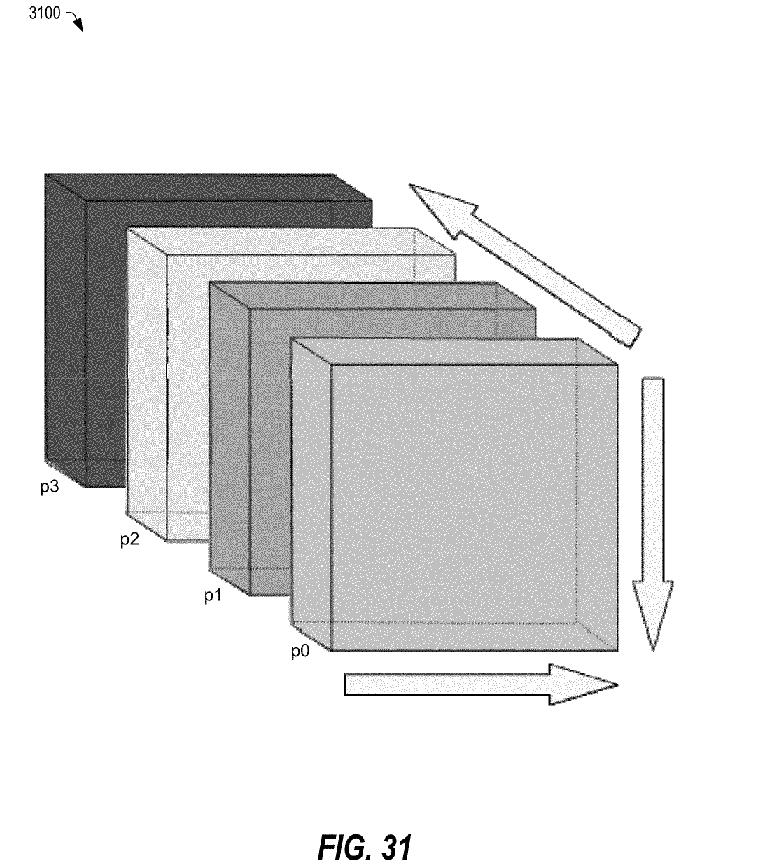

FIG. 31 depicts a block diagram of three steps of a three-dimensional FFT computational process 3100 across four cores, in accordance with certain embodiments of the present disclosure. The conceptual diagram of the process 3100 represents FFT processes performed by each core and across each core.

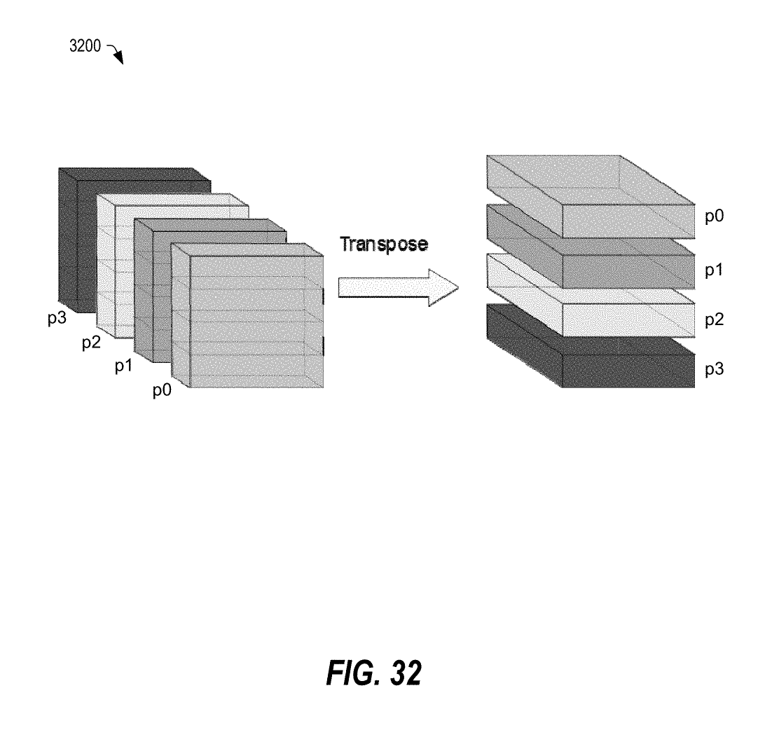

FIG. 32 depicts a block diagram of a global transpose 3200 of a cube process across four cores, in accordance with certain embodiments of the present disclosure. The transpose 3200 includes a transpose applied to the data produced by each core.

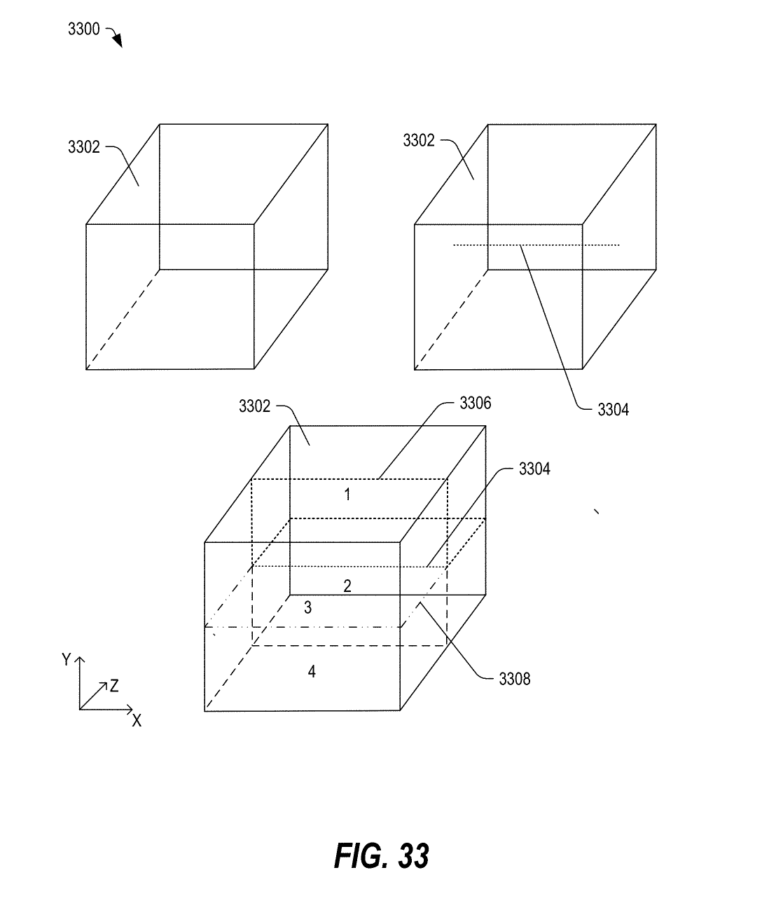

Contrary to the representations of FIGS. 30 through 32, embodiments of the multi-dimensional, parallel FFT may partition data from inside the cube. The methods may be represented by the three different models depicted in FIGS. 33-35 for the 4-cores partition model in accordance with certain embodiments of the present disclosure.

FIG. 33 depicts a block diagram of a first model 3300 of a three-dimensional parallelization process over four cores, in accordance with certain embodiments of the present disclosure. According to the first model 3300 in FIG. 33, a data block 3302 represents a 3D matrix of data. A horizontal axis 3304 (extending in the X-Direction) is determined at a center of the data block 3302. Then, the horizontal axis 3304 is intersected by a first plane 3306 and a second plane 3308 to partition the matrix into four 3D matrices (1 through 4). In this example, the data block 3302 may be a data cube that can be divided into four rectangular prism matrices.

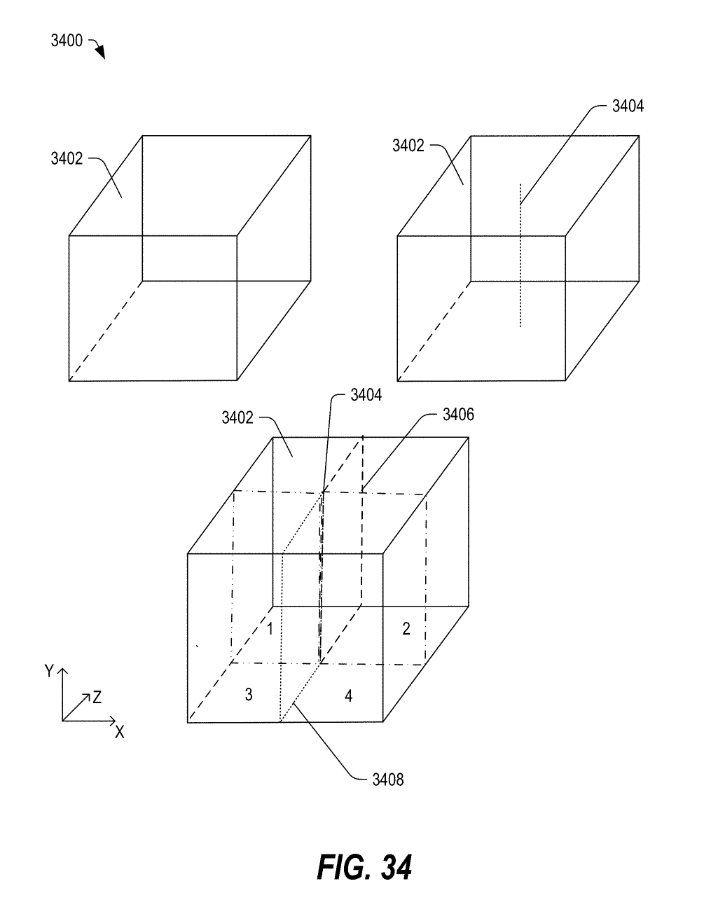

FIG. 34 depicts a block diagram of a second model 3400 of a three-dimensional parallelization process over four cores, in accordance with certain embodiments of the present disclosure. According to the second model 3400 in FIG. 34, a data block 3402 represents a 3D matrix of data. A vertical axis 3404 (extending in the Y-Direction) is determined at a center of the data block 3402. Then, the vertical axis 3404 is intersected by a first plane 3406 and a second plane 3408 to partition the matrix into four 3D matrices (1 through 4). In this example, the data block 3402 may be a data cube that can be divided into four rectangular prism matrices.

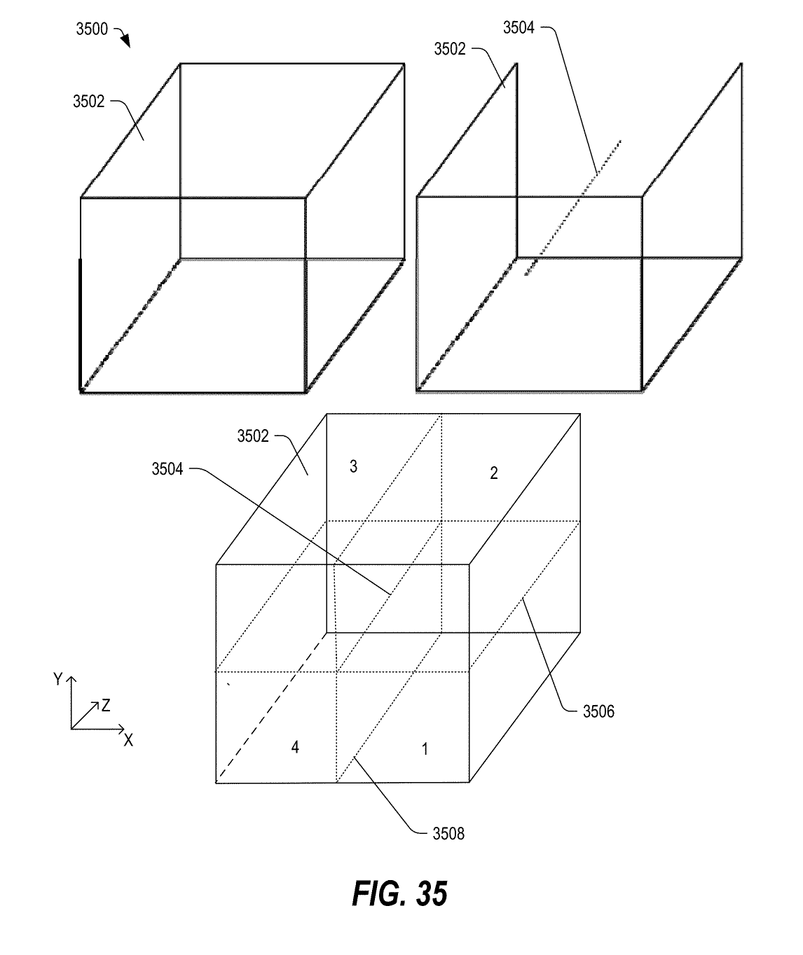

FIG. 35 depicts a block diagram of a third model 3500 of a three-dimensional parallelization process over four cores, in accordance with certain embodiments of the present disclosure. According to the third model 3500, a data block 3502 represents a 3D matrix of data. A horizontal axis 3504 (extending in the Z-Direction) is determined at a center of the data block 3502. Then, the horizontal axis 3504 is intersected by a first plane 3506 and a second plane 3508 to partition the matrix into four 3D matrices (1-4).

Based on the first Model, equation (29) can be rewritten as follows:

$${X}_{( {k}_{1} , {k}_{2} , {k}_{3} )} = [ \begin{matrix}{\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {pn}_{2} , {pn}_{3} )} {w}_{{N}_{1}}^{{n}_{1} {k}_{1}} {w}_{{N}_{2}}^{{pn}_{2} {k}_{2}} {w}_{{N}_{3}}^{{pn}_{3} {k}_{3}} + \\ {\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {pn}_{2} + 1 , {pn}_{3} + 1 )} {w}_{{N}_{1}}^{{n}_{1} {k}_{1}} {w}_{{N}_{2}}^{( {pn}_{2} + 1 ) {k}_{2}} {w}_{{N}_{3}}^{( {pn}_{3} + 1 ) {k}_{3}} + \\ K + {\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {pn}_{2} + ( P - 1 ) , {pn}_{3} + ( P - 1 ) )} {w}_{{N}_{1}}^{{n}_{1} {k}_{1}} {w}_{{N}_{2}}^{( {pn}_{2} + ( P - 1 ) ) {k}_{2}} {w}_{{N}_{3}}^{( {pn}_{3} + ( P - 1 ) ) {k}_{3}}\end{matrix} ] \\ {k}_{1} ∈ [ 0 , {N}_{1} - 1 ] , {k}_{2} ∈ [ 0 , {N}_{2} - 1 ] , {k}_{3} ∈ [ 0 , {N}_{3} - 1 ] . \qquad ( 31 )$$

That could be simplified as:

$${X}_{( {k}_{1} , {k}_{2} , {k}_{3} )} = [ \begin{matrix}{\sum }_{{n}_{1} = 0}^{{N}_{1} - 1} {\sum }_{{n}_{2} = 0}^{\frac{{N}_{2}}{P} - 1} {\sum }_{{n}_{3} = 0}^{\frac{{N}_{3}}{P} - 1} {x}_{( {n}_{1} , {pn}_{2} , {pn}_{3} )} {w}_{{N}_{1}}^{{n}_{1} {k}_{1}} {w}_{\frac{{N}_{2}}{P}}^{{n}_{2} {k}_{2}} {w}_{\frac{{N}_{3}}{P}}^{{n}_{3} {k}_{3}} + \\ {w}_{{N}_{2}}^{{k}_{2}} {w}_{{N}_{3}}^{{k}_{3}} {\sum }_{{n}_{1} = 0}^{{N}_{1} - 1} {\sum }_{{n}_{2} = 0}^{\frac{{N}_{2}}{P} - 1} {\sum }_{{n}_{3} = 0}^{\frac{{N}_{3}}{P} - 1} {x}_{( {n}_{1} , {pn}_{2} + 1 , {pn}_{3} + 1 )} {w}_{{N}_{1}}^{{n}_{1} {k}_{1}} {w}_{\frac{{N}_{2}}{P}}^{{n}_{2} {k}_{2}} {w}_{\frac{{N}_{3}}{P}}^{{n}_{3} {k}_{3}} + \\ K + {w}_{{N}_{2}}^{( P - 1 ) {k}_{2}} {w}_{{N}_{3}}^{( P - 1 ) {k}_{3}} {\sum }_{{n}_{1} = 0}^{{N}_{1} - 1} {\sum }_{{n}_{2} = 0}^{\frac{{N}_{2}}{P} - 1} {\sum }_{{n}_{3} = 0}^{\frac{{N}_{3}}{P} - 1} {x}_{( {n}_{1} , {pn}_{2} + ( P - 1 ) , {pn}_{3} + ( P - 1 ) )} {w}_{{N}_{1}}^{{n}_{1} {k}_{1}} {w}_{\frac{{N}_{2}}{P}}^{{n}_{2} {k}_{2}} {w}_{\frac{{N}_{3}}{P}}^{{n}_{3} {k}_{3}}\end{matrix} ] \\ {k}_{1} ∈ [ 0 , {N}_{1} - 1 ] , {k}_{2} ∈ [ 0 , {N}_{2} - 1 ] , {k}_{3} ∈ [ 0 , {N}_{3} - 1 ] \qquad ( 32 )$$

By defining v₂=0, 1, . . . , V₂−1, v₃=0, 1, V₃−1 and q=0, 1, . . . , P−1 where V₂=N₂/p and V₃=N₃/p, the indices k₂ and k₃ can be determined as follows:

k₂=v₂+qV₂,

k₃=v₃+qV₃ (33)

As a result, Equation 32 could be expressed as follows:

$${X}_{( {k}_{1} , {v}_{2} + {qV}_{2} , {v}_{3} + {qV}_{3} )} = [ \begin{matrix}{\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {pn}_{2} , {pn}_{3} )} {w}_{{N}_{1}}^{{n}_{1} {k}_{1}} {w}_{{V}_{2}}^{{n}_{2} ( {v}_{2} + {qV}_{2} )} {w}_{{V}_{3}}^{{n}_{3} ( {v}_{3} + {qV}_{3} )} + \\ {w}_{{N}_{2}}^{( {v}_{2} + {qV}_{2} )} {w}_{{N}_{3}}^{( {v}_{3} + {qV}_{3} )} {\sum }_{{n}_{1} = 0}^{{N}_{1} - 1} {\sum }_{{n}_{2} = 0}^{{V}_{2} - 1} {\sum }_{{n}_{3} = 0}^{{V}_{3} - 1} {x}_{( {n}_{1} , {pn}_{2} + 1 , {pn}_{3} + 1 )} {w}_{{N}_{1}}^{{n}_{1} {k}_{1}} {w}_{{V}_{2}}^{{n}_{2} ( {v}_{2} + {qV}_{2} )} {w}_{{V}_{3}}^{{n}_{3} ( {v}_{3} + {qV}_{3} )} + \\ K + {w}_{{N}_{2}}^{( P - 1 ) ( {v}_{2} + {qV}_{2} )} {w}_{{N}_{3}}^{( P - 1 ) ( {v}_{3} + {qV}_{3} )} {\sum }_{{n}_{1} = 0}^{{N}_{1} - 1} {\sum }_{{n}_{2} = 0}^{{V}_{2} - 1} {\sum }_{{n}_{3} = 0}^{{V}_{3} - 1} {x}_{( {n}_{1} , {pn}_{2} + ( P - 1 ) , {pn}_{3} + ( P - 1 ) )} {w}_{{N}_{1}}^{{n}_{1} {k}_{1}} {w}_{{V}_{2}}^{{n}_{2} ( {v}_{2} + {qV}_{2} )} {w}_{{V}_{3}}^{{n}_{3} ( {v}_{3} + {qV}_{3} )}\end{matrix} ] \\ {k}_{1} ∈ [ 0 , {N}_{1} - 1 ] , {v}_{2} ∈ [ 0 , {V}_{2} - 1 ] , {v}_{3} ∈ [ 0 , {V}_{3} - 1 ] \qquad ( 34 )$$

Considering that variable (w) in equation (34) may be equal to one, the values may be determined as follows:

w_{V}_{₂}ⁿ^{₂}^{qV}^{₂}=(w_{V}_{₂}^{V}^{₂})ⁿ^{₁}^{q}=(1)ⁿ^{₂}^{q}=1,

w_{V}_{₃}ⁿ^{₃}^{qV}^{₃}=(w_{V}_{₃}^{V}^{₃})ⁿ^{₃}^{q}×(1)ⁿ^{₃}^{q}×1 (35)

Therefore, equation (34) can be rewritten as follows:

$${X}_{( {k}_{1} , {v}_{2} + {qV}_{2} , {v}_{3} + {qV}_{3} )} = [ \begin{matrix}{\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {pn}_{2} , {pn}_{3} )} {w}_{{N}_{1}}^{{n}_{1} {k}_{1}} {w}_{{V}_{2}}^{{n}_{2} {v}_{2}} {w}_{{V}_{3}}^{{n}_{3} {v}_{3}} + \\ {w}_{{N}_{2}}^{{v}_{2}} {q}_{{N}_{2}}^{{qV}_{2}} {w}_{{N}_{3}}^{{v}_{3}} {w}_{{N}_{3}}^{{qV}_{3}} {\sum }_{{n}_{1} = 0}^{{N}_{1} - 1} {\sum }_{{n}_{2} = 0}^{{V}_{2} - 1} {\sum }_{{n}_{3} = 0}^{{V}_{3} - 1} {x}_{( {n}_{1} , {pn}_{2} + 1 , {pn}_{3} + 1 )} {w}_{{N}_{1}}^{{n}_{1} {k}_{1}} {w}_{{V}_{2}}^{{n}_{2} {v}_{2}} {w}_{{V}_{3}}^{{n}_{3} {v}_{3}} + \\ K + {w}_{{N}_{2}}^{( P - 1 ) {v}_{2}} {w}_{{N}_{2}}^{( P - 1 ) {qV}_{2}} {w}_{{N}_{3}}^{( P - 1 ) {v}_{3}} {w}_{{qV}_{3}}^{( P - 1 )} {\sum }_{{n}_{1} = 0}^{{N}_{1} - 1} {\sum }_{{n}_{2} = 0}^{{V}_{2} - 1} {\sum }_{{n}_{3} = 0}^{{V}_{3} - 1} {x}_{( {n}_{1} , {pn}_{2} + ( P - 1 ) , {pn}_{3} + ( P - 1 ) )} {w}_{{N}_{1}}^{{n}_{1} {k}_{1}} {w}_{{V}_{2}}^{{n}_{2} {v}_{2}} {w}_{{V}_{3}}^{{n}_{3} {v}_{3}}\end{matrix} ] \\ {k}_{1} ∈ [ 0 , {N}_{1} - 1 ] , {v}_{2} ∈ [ 0 , {V}_{2} - 1 ] , {v}_{3} ∈ [ 0 , {V}_{3} - 1 ] \qquad ( 36 )$$

If X₍ₖ_{₁}_{,k}_{₂}_{,k}_{₃}₎ is the N₁^{th}×N₂^{th}×N₃^{th} order 3D-Fourier transform

$${\sum }_{{n}_{1} = 0}^{{N}_{1} - 1} {\sum }_{{n}_{2} = 0}^{{N}_{2} - 1} {\sum }_{{n}_{3} = 0}^{{N}_{3} - 1} {x}_{( {n}_{1} , {n}_{2} , {n}_{3} )} {w}_{{N}_{1}}^{{n}_{1} {k}_{1}} {w}_{{N}_{2}}^{{n}_{2} {k}_{2}} {w}_{{N}_{3}}^{{n}_{3} {k}_{3}} then , \\ {X}_{{( 0 )}_{( {k}_{1} , {v}_{1} , {v}_{2} )}} , {X}_{{( 1 )}_{( {k}_{1} , {v}_{1} , {v}_{2} )}} , … and {X}_{{( p - 1 )}_{( {k}_{1} , {v}_{1} , {v}_{2} )}} ,$$

will be the N₁^{th}×N₂^{th}/P×N₃^{th}/P order Fourier transforms given respectively by the following expressions

$${\sum }_{{n}_{1} = 0}^{{N}_{1} - 1} {\sum }_{{n}_{2} = 0}^{{V}_{2} - 1} {\sum }_{{n}_{3} = 0}^{{V}_{3} - 1} {x}_{( {n}_{1} , {pn}_{1} , {pn}_{2} )} {w}_{{N}_{1}}^{{n}_{1} {k}_{1}} {w}_{{V}_{2}}^{{n}_{2} {v}_{2}} {w}_{{V}_{3}}^{{n}_{3} {v}_{3}} , \\ {\sum }_{{n}_{1} = 0}^{{N}_{1} - 1} {\sum }_{{n}_{2} = 0}^{{V}_{2} - 1} {\sum }_{{n}_{3} = 0}^{{V}_{3} - 1} {x}_{( {n}_{1} , {pn}_{2} + 1 , {pn}_{3} + 1 )} {w}_{{N}_{1}}^{{n}_{1} {k}_{1}} {w}_{{V}_{2}}^{{n}_{2} {v}_{2}} {w}_{{V}_{3}}^{{n}_{3} {v}_{3}} , … and$$

$${\sum }_{{n}_{1} = 0}^{{N}_{1} - 1} {\sum }_{{n}_{2} = 0}^{{V}_{2} - 1} {\sum }_{{n}_{3} = 0}^{{V}_{3} - 1} {x}_{( {n}_{1} , {pn}_{2} + ( P - 1 ) , {pn}_{3} + ( P - 1 ) )} {w}_{{N}_{1}}^{{n}_{1} {k}_{1}} {w}_{{V}_{2}}^{{n}_{2} {v}_{2}} {w}_{{V}_{3}}^{{n}_{3} {v}_{3}} .$$

Based on the above assumption, equation (36) can be rewritten as follows:

$${X}_{( {k}_{1} , {v}_{1} + {qV}_{1} , {v}_{2} + {qV}_{2} )} = {X}_{{( 0 )}_{( {k}_{1} , {v}_{1} , {v}_{2} )}} + ( {w}_{{N}_{2}}^{{v}_{2}} {w}_{{N}_{2}}^{{qV}_{2}} {w}_{{N}_{3}}^{{v}_{3}} {w}_{{N}_{3}}^{{qV}_{3}} ) {X}_{{( 1 )}_{( {k}_{1} , {v}_{1} , {v}_{2} )}} + L + ( {w}_{{N}_{2}}^{( P - 1 ) {v}_{2}} {w}_{{N}_{2}}^{( P - 1 ) {pV}_{2}} {w}_{{N}_{3}}^{( P - 1 ) {v}_{3}} {w}_{{N}_{3}}^{( P - 1 ) {qV}_{3}} ) {X}_{{( p - 1 )}_{( {k}_{1} , {v}_{1} , {v}_{2} )}} \qquad ( 37 )$$

In some examples, equation (37) can be expanded as follows:

$$\begin{matrix}{X}_{( {k}_{1} , {k}_{2} , {k}_{3} )} = [ \begin{matrix}{X}_{( {k}_{1} , {v}_{1} , {v}_{2} )} \\ {X}_{( {k}_{1} , {v}_{1} + {V}_{1} , {v}_{2} + {V}_{2} )} \\ M \\ {X}_{( {k}_{1} , {v}_{1} + ( p - 1 ) {V}_{1} , {v}_{2} + ( p - 1 ) {V}_{2} )}\end{matrix} ] \\ = [ \begin{matrix}[ \begin{matrix}{w}_{{N}_{2}}^{0} & {w}_{{N}_{2}}^{0} & L & {w}_{{N}_{2}}^{0} \\ {w}_{{N}_{2}}^{0} & {w}_{{N}_{2}}^{\frac{{N}_{2}}{p}} & L & {w}_{{N}_{2}}^{\frac{( p - 1 ) {N}_{2}}{p}} \\ M & M & O & M \\ {w}_{{N}_{2}}^{0} & {w}_{{N}_{2}}^{\frac{( p - 1 ) {N}_{2}}{p}} & L & {w}_{{N}_{3}}^{\frac{{( p - 1 )}^{2} {N}_{2}}{p}}\end{matrix} ] \times [ \begin{matrix}{w}_{{N}_{2}}^{0} & 0 & L & 0 \\ 0 & {w}_{{N}_{2}}^{{v}_{2}} & 0 & 0 \\ M & M & O & M \\ 0 & 0 & L & {w}_{{N}_{2}}^{( p - 1 ) {v}_{2}}\end{matrix} ] \times \\ [ \begin{matrix}{w}_{{N}_{3}}^{0} & {w}_{{N}_{3}}^{0} & L & {w}_{{N}_{3}}^{0} \\ {w}_{{N}_{3}}^{0} & {w}_{{N}_{3}}^{\frac{{N}_{3}}{p}} & L & {w}_{{N}_{3}}^{\frac{( p - 1 ) {N}_{3}}{p}} \\ M & M & O & M \\ {w}_{{N}_{3}}^{0} & {w}_{{N}_{3}}^{\frac{( p - 1 ) {N}_{3}}{p}} & L & {w}_{{N}_{3}}^{\frac{{( p - 1 )}^{2} {N}_{3}}{p}}\end{matrix} ] \times [ \begin{matrix}{w}_{{N}_{3}}^{0} & 0 & L & 0 \\ 0 & {w}_{{N}_{3}}^{{v}_{3}} & 0 & 0 \\ M & M & O & M \\ 0 & 0 & L & {w}_{{N}_{3}}^{( p - 1 ) {v}_{3}}\end{matrix} ] \times \\ [ \begin{matrix}{X}_{{( 0 )}_{( {k}_{1} , {v}_{1} , {v}_{2} )}} \\ {X}_{{( 1 )}_{( {k}_{1} , {v}_{1} , {v}_{2} )}} \\ M \\ {X}_{{( p - 1 )}_{( {k}_{1} , {v}_{1} , {v}_{2} )}}\end{matrix} ]\end{matrix} ]\end{matrix} \qquad ( 38 )$$

In equation (38), the term (X_{(k1, k2, k3)}) represents the combination phase in the k₃ dimension as follows:

$$\begin{matrix}{X}_{( {k}_{1} , {k}_{2} , {k}_{3} )} = [ \begin{matrix}{X}_{( {k}_{1} , {v}_{1} , {v}_{2} )} \\ {X}_{( {k}_{1} , {v}_{1} + {V}_{1} , {v}_{2} + {V}_{2} )} \\ M \\ {X}_{( {k}_{1} , {v}_{1} + ( p - 1 ) {V}_{1} , {v}_{2} + ( p - 1 ) {V}_{2} )}\end{matrix} ] \\ = [ \begin{matrix}[ \begin{matrix}{w}_{{N}_{3}}^{0} & {w}_{{N}_{3}}^{0} & L & {w}_{{N}_{3}}^{0} \\ {w}_{{N}_{3}}^{0} & {w}_{{N}_{3}}^{\frac{{N}_{3}}{p}} & L & {w}_{{N}_{3}}^{\frac{( p - 1 ) {N}_{3}}{p}} \\ M & M & O & M \\ {w}_{{N}_{3}}^{0} & {w}_{{N}_{3}}^{\frac{( p - 1 ) {N}_{3}}{p}} & L & {w}_{{N}_{3}}^{\frac{{( p - 1 )}^{2} {N}_{3}}{p}}\end{matrix} ] \times [ \begin{matrix}{w}_{{N}_{3}}^{0} & 0 & L & 0 \\ 0 & {w}_{{N}_{3}}^{{v}_{3}} & 0 & 0 \\ M & M & O & M \\ 0 & 0 & L & {w}_{{N}_{3}}^{( p - 1 ) {v}_{3}}\end{matrix} ] \times \\ [ \begin{matrix}{X}_{{( 0 )}_{( {k}_{1} , {v}_{1} , {v}_{2} )}} \\ {X}_{{( 1 )}_{( {k}_{1} , {v}_{1} , {v}_{2} )}} \\ M \\ {X}_{{( p - 1 )}_{( {k}_{1} , {v}_{1} , {v}_{2} )}}\end{matrix} ]\end{matrix} ]\end{matrix} \qquad ( 39 )$$

Further, in equation (38), the term (X(k1, k2, k3)) can represent the combination phase in the k2 dimension as follows:

$$\begin{matrix}{X}_{( {k}_{1} , {k}_{2} , {k}_{3} )} = [ \begin{matrix}{X}_{( {k}_{1} , {v}_{1} , {k}_{2} )} \\ {X}_{( {k}_{1} , {v}_{1} + {V}_{1} , {k}_{2} )} \\ M \\ {X}_{( {k}_{1} , {v}_{1} + ( p - 1 ) {V}_{1} , {k}_{2} )}\end{matrix} ] \\ = [ \begin{matrix}[ \begin{matrix}{w}_{{N}_{2}}^{0} & {w}_{{N}_{2}}^{0} & L & {w}_{{N}_{2}}^{0} \\ {w}_{{N}_{2}}^{0} & {w}_{{N}_{2}}^{\frac{{N}_{2}}{p}} & L & {w}_{{N}_{2}}^{\frac{( p - 1 ) {N}_{2}}{p}} \\ M & M & O & M \\ {w}_{{N}_{2}}^{0} & {w}_{{N}_{2}}^{\frac{( p - 1 ) {N}_{2}}{p}} & L & {w}_{{N}_{3}}^{\frac{{( p - 1 )}^{2} {N}_{2}}{p}}\end{matrix} ] \times [ \begin{matrix}{w}_{{N}_{2}}^{0} & 0 & L & 0 \\ 0 & {w}_{{N}_{2}}^{{v}_{2}} & 0 & 0 \\ M & M & O & M \\ 0 & 0 & L & {w}_{{N}_{2}}^{( p - 1 ) {v}_{2}}\end{matrix} ] \times \\ [ \begin{matrix}{X}_{{( 0 )}_{( {k}_{1} , {v}_{1} , {k}_{3} )}} \\ {X}_{{( 1 )}_{( {k}_{1} , {v}_{1} , {k}_{3} )}} \\ M \\ {X}_{{( p - 1 )}_{( {k}_{1} , {v}_{1} , {k}_{3} )}}\end{matrix} ]\end{matrix} ]\end{matrix} \qquad ( 40 )$$

For the variable (P) representing a number of processor cores (e.g., P=4), the data are populated into the four generated cubes according to the source code of FIG. 44.

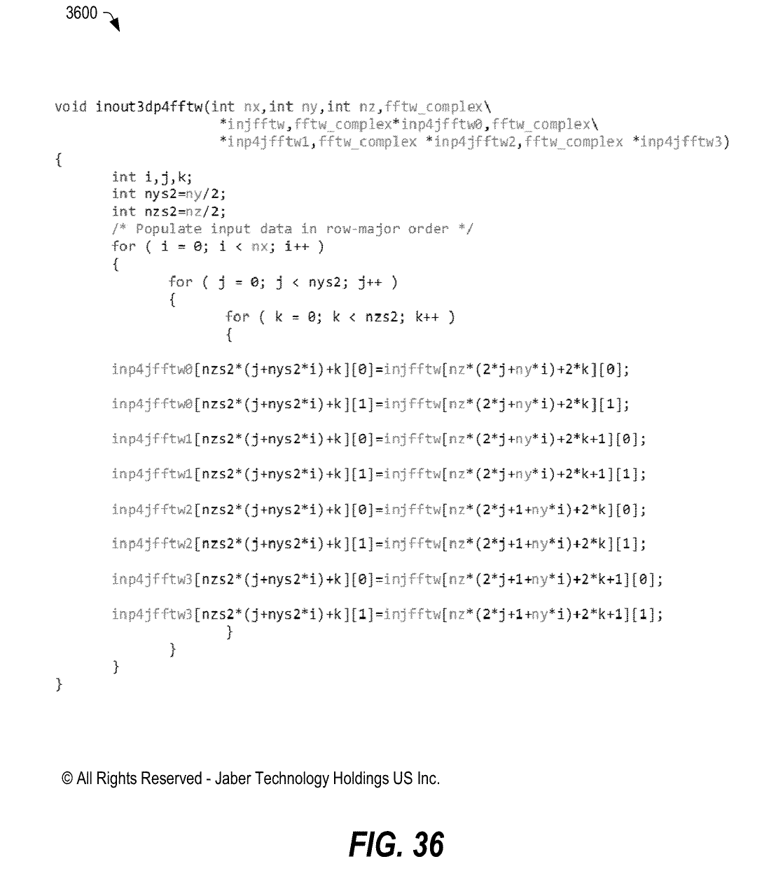

FIG. 36 depicts MATLAB source code 3600 illustrating a three-dimensional parallelization process across four cores, in accordance with certain embodiments of the present disclosure. The source code 3600 depicts the process of dividing the input data cube into four 3D matrices according to the first model 3300 in FIG. 33. Using nested for loops, the source code 3600 divides the input data block into four 3D matrices, which can be processed to produce an FFT output.

In conjunction with the methods, devices, and systems described above with respect to FIGS. 1-36, a parallelized multi-dimensional FFT is disclosed that can utilize the multiple threads and cores of a multi-core processor to determine an FFT, improving the overall speed and processing functionality of the processor. The FFT algorithm may be executed by one or more CPU cores and can be configured to operate with arbitrary sized inputs and with a selected radix. The FFT algorithm can be used to determine the FFT of input data, which input data has a size that is a multiple of an arbitrary integer a. The FFT algorithm may utilize three counters to access the data and the coefficient multipliers at each stage of the FFT processor, reducing memory accesses to the coefficient multipliers.

The processes, machines, and manufactures (and improvements thereof) described herein are particularly useful improvements for computers that process complex data. Further, the embodiments and examples herein provide improvements in the technology of image processing systems. In addition, embodiments and examples herein provide improvements to the functioning of a computer by enhancing the speed of the processor in handling complex mathematical computations (such as fluid flow dynamics, and other complex calculations) by reducing the overall number of memory accesses (read and write operations) performed in order to complete the computations and by processing input data streams into matrices that take advantage of multi-threaded, multi-core processor architectures to enhance overall data processing speeds without sacrificing accuracy. Thus, the improvements provided by the FFT implementations described herein provide for technical advantages, such as providing a system in which real-time signal processing and off-line spectral analysis are performed more quickly than conventional devices, because the overall number of memory accesses (which can introduce delays) are reduced. Further, the radix-r FFT can be used in a variety of data processing systems to provide faster, more efficient data processing. Such systems may include speech, satellite and terrestrial communications; wired and wireless digital communications; multi-rate signal processing; target tracking and identifications; radar and sonar systems; machine monitoring; seismology; fluid-flow dynamics; biomedicine; encryption; video processing; gaming; convolution neural networks; digital signal processing; image processing; speech recognition; computational analysis; autonomous cars; deep learning; and other applications. For example, the systems and processes described herein can be particularly useful to any systems in which it is desirable to process large amounts of data in real time or near real time. Further, the improvements herein provide additional technical advantages, such as providing a system in which the number of memory accesses can be reduced. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
a memory configured to store data at a plurality of addresses; and
a processor circuit including a plurality of processor cores, each processor core including multiple threads, the processor circuit configure to:
subdivide an input data stream into a plurality of three-dimensional matrices corresponding to a number of processor cores of the processor circuit;
associate each matrix with a respective one of the plurality of processor cores; and
determine concurrently a three-dimensional Fast Fourier Transform (FFT) for each matrix of the plurality of three-dimensional matrices within the respective one of the plurality of processor cores to produce a plurality of partial FFTs.

2. The apparatus of claim 1, wherein the processor circuit is further configured to combine the plurality of partial FFTs in parallel to produce an FFT output.

3. The apparatus of claim 1, wherein the processor is configured to subdivide the input stream by partitioning of the input stream into a number of blocks of contiguous data elements and by assigning to each processor core one of the number of blocks, each block having a size corresponding to a number of bits of the input stream divided by the number of processor cores.

4. The apparatus of claim 3, wherein the processor cores are configured to exchange outputs between a second-to-last and a last stage of a pipelined Radix-r structure.

5. The apparatus of claim 3, wherein:
the plurality of processor cores includes a number of processing cores; and
the plurality of processor cores executes the number of FFTs of size N-bits divided by the number of processor cores in parallel.

6. The apparatus of claim 1, wherein data is passed between threads of a given processor core of the plurality of processing cores and not between the plurality of processing cores until a data reordering stage of the three-dimensional FFT.

7. A method of determining a Fast Fourier Transformation of comprising:
automatically subdividing, using a processing circuit including a number of processor cores, an input data stream into a plurality of three-dimensional matrices corresponding to the number of processor cores of the processing circuit;
associating each matrix of the plurality of three-dimensional matrices with a respective one of the plurality of processor cores automatically via the processing circuit; and
determining concurrently a three-dimensional FFT for each matrix of the plurality of three-dimensional matrices within the respective one of the plurality of processor cores to produce a plurality of partial FFTs.

8. The method of claim 7, further comprising combining the plurality of partial FFTs in parallel to determine an FFT.

9. The method of claim 7, wherein determining concurrently the three-dimensional FFT comprises:
passing data between threads of a given processor core of the plurality of processing cores; and
passing data between processing cores of the plurality of processing cores only during a data reordering stage of the three-dimensional FFT.

10. The method of claim 7, further comprising combining the plurality of partial FFTs in parallel to produce an FFT output.

11. The method of claim 7, wherein automatically subdividing the input data stream comprises:
automatically partitioning the input stream into a number of blocks of contiguous data elements; and
automatically assigning to each processor core one of the number of blocks, each block having a size corresponding to a number of bits of the input stream divided by the number of processor cores.

12. The method of claim 7, wherein determining concurrently a three-dimensional FFT for each matrix of the plurality of three-dimensional matrices includes executing a same instruction of an FFT transformation operation simultaneously on each processor core of the number of processor cores.

13. The method of claim 7, wherein each of the plurality of three-dimensional matrices represents a discrete Fourier Transform block of data that is processed by the processing circuit to produce a plurality of Nth order FFTs in parallel.

14. An apparatus comprising:
a memory configured to store data at a plurality of addresses; and
a processor circuit including a plurality of processor cores, each processor core including multiple threads, the processor circuit configure to:
subdivide an input data stream into a plurality of matrices corresponding to a number of processor cores of the processor circuit;
associate each matrix of the plurality of matrices with a respective one of the plurality of processor cores;
determine concurrently, using the plurality of processor cores, a Fast Fourier Transform (FFT) for each matrix of the plurality of matrices within the associated one of the plurality of processor cores to produce a plurality of partial FFTs; and
automatically combine the plurality of partial FFTs to produce an FFT output.

15. The apparatus of claim 14, wherein each of the plurality of matrices comprises a three-dimensional matrix representing a discrete Fourier Transform data block.

16. The apparatus of claim 15, wherein the processor circuit is configured to subdivide the input stream by partitioning of the input stream into a number of blocks of contiguous data elements and by assigning to each processor core one of the number of blocks, each block having a size corresponding to a number of bits of the input stream divided by the number of processor cores.

17. The apparatus of claim 16, wherein the plurality of processor cores are configured to exchange outputs between a second-to-last and a last stage of a pipelined Radix-r structure.

18. The apparatus of claim 16, wherein:
the plurality of processor cores includes a number of processing cores; and
the plurality of processor cores executes in parallel the number of FFTs of size N-bits divided by the number of processor cores.

19. The apparatus of claim 14, wherein data is passed between threads of a given processor core of the plurality of processing cores and not between the plurality of processing cores until a data reordering stage of a FFT operation.

20. The apparatus of claim 14, wherein the processor core determines concurrently the FFT of each matrix by executing a same instruction of an FFT transformation operation simultaneously on each processor core of the plurality of processor cores.
